(19) United States
(12) Patent Application Publication
(10) Pub. No.: US 2003/0202520 A1
(43) Pub. Date: Oct. 30, 2003

(54) Scalable switch fabric system and apparatus for computer networks

(75) Inventors: Michael Witkowski, Tomball, TX (US); Lih-Sheng Chiou, San Jose, CA (US); Sompong Paul Olarig, Pleasanton, CA (US); John E. Jenne, Houston, TX (US); Miles Borromeo Reyes, Tomball, TX (US)

Correspondence Address: BAKER BOTTS, LLP, 910 LOUISIANA, HOUSTON, TX, 77002-4995, US

(73) Assignee: MaXXan Systems, Inc.

(21) Appl. No.: 10/132,988

(22) Filed: Apr. 26, 2002

(51) Int. Cl. H04L 12/66

(52) U.S. Cl. 370/400; 370/422; 370/398; 370/395.1

(57) ABSTRACT

A scalable switch fabric system and apparatus for computer networks. The scalable switch fabric system and apparatus comprises a Switch Fabric Subsystem, Input-Output Subsystems, Application Subsystems and System Control Subsystems. The Switch Fabric Subsystem is a protocol agnostic cell or packet switching infrastructure that provides scalable interconnections between the Input-Output Subsystems and Application Subsystems. The Switch Fabric Subsystem provides primary data paths for network traffic being moved by the switch. The Input-Output Subsystems connect to the external network devices that use the switch to communicate with other external network devices. The Input-Output Subsystems are part of the data path and do low level decoding of ingress frames from the external ports; switching/routing, identifying the destination Input-Output Subsystems for the frame; and queuing the frame for transmission through the Switch Fabric. The System Control Subsystems provide overall management of the scalable switch fabric system and apparatus.

### CROSS-REFERENCE TO RELATED APPLICATIONS

This application is related to U.S. patent application Ser. No. ______ [attorney docket number 069099.0104/client reference 106-02] entitled “System and Method for Scalable Switch Fabric for Computer Network” by [name inventors], which is being filed contemporaneously with the present application and which is incorporated herein by reference in its entirety for all purposes. This application is also related to previously filed and pending U.S. patent application Ser. No. 09/738,960, entitled “Caching System and Method for a Network Storage System” by Lin-Sheng Chiou, Mike Witkowski, Hawkins Yao, Cheh-Suei Yang, and Sompong Paul Olarig, which was filed on Dec. 14, 2000 and which is incorporated herein by reference in its entirety for all purposes; U.S. patent application Ser. No. 10/015,047 [attorney docket number 069099.0102/B2] entitled “System, Apparatus and Method for Address Forwarding for a Computer Network” by Hawkins Yao, Cheh-Suei Yang, Richard Gunlock, Michael L. Witkowski, and Sompong Paul Olarig, which was filed on Oct. 26, 2001 and which is incorporated herein by reference in its entirety for all purposes; U.S. patent application Ser. No. 10/039,190 [attorney docket number 069099.0105/B5] entitled “Network Processor Interface System” by Sompong Paul Olarig, Mark Lyndon Oelke, and John E. Jenne, which was filed on Dec. 31, 2001, and which is incorporated herein by reference in its entirety for all purposes; U.S. patent application Ser. No. 10/039,189 [attorney docket number 069099.0106/B6-A] entitled “Xon/Xoff Flow Control for Computer Network” by Hawkins Yao, John E. Jenne, and Mark Lyndon Oelke, which was filed on Dec. 31, 2001, and which is incorporated herein by reference in its entirety for all purposes; U.S. patent application Ser. No. 10/039,184 [attorney docket number 069099.0107/B6-B] entitled “Buffer to Buffer Flow Control for Computer Network” by John E. Jenne, Mark Lyndon Oelke and Sompong Paul Olarig, which was filed on Dec. 31, 2001, and which is incorporated herein by reference in its entirety for all purposes; U.S. patent application Ser. No. 10/117,418 [attorney docket number 069099.0109/(client reference 115-02)], entitled “System and Method for Linking a Plurality of Network Switches,” by Ram Ganesan Iyer, Hawkins Yao and Michael Witkowski, which was filed Apr. 5, 2002 and which is incorporated herein by reference in its entirety for all purposes; U.S. patent application Ser. No. 10/117,040 [attorney docket number 069099.0111/(client reference 135-02)], entitled “System and Method for Expansion of Computer Network Switching System Without Disruption Thereof,” by Mark Lyndon Oelke, John E. Jenne, Sompong Paul Olarig, Gary Benedict Kotzur and Matthew John Schumacher, which was filed Apr. 5, 2002 and which is incorporated herein by reference in its entirety for all purposes; U.S. patent application Ser. No. 10/117,266 [attorney docket number 069099.0112/(client reference 220-02)], entitled “System and Method for Guaranteed Link Layer Flow Control,” by Hani Ajus and Chung Dai, which was filed Apr. 5, 2002 and which is incorporated herein by reference in its entirety for all purposes; U.S. patent application Ser. No. 10/117,638 [attorney docket number 069099.0113/(client reference 145-02)], entitled Fibre Channel Implementation Using Network Processors,” by Hawkins Yao, Richard Gunlock and Po-Wei Tan, which was filed Apr. 5, 2002 and which is incorporated herein by reference in its entirety for all purposes; U.S. patent application Ser. No. 10/117,290 [attorney docket number 069099.0114/(client reference 230-02)], entitled “Method and System for Reduced Distributed Event Handling in a Network Environment,” by Ruotao Huang and Ram Ganesan Iyer, which was filed Apr. 5, 2002 and which is incorporated herein by reference in its entirety for all purposes; and U.S. patent application Ser. No. ______ [attorney docket number 069099.0115/(client reference 225-02)], entitled “System and Method for Allocating Unique Zone Membership,” by Walter Bramhall and Ruotag Huang, which was filed Apr. 15, 2002 and which is incorporated herein by reference in its entirety for all purposes; and U.S. patent application Ser. No. ______ [attorney docket number 069099.0108/(client reference 140-02)], entitled “System and Method for Load Sharing Computer Network Switch,” by Mark Lyndon Oelke, John E. Jenne and Sompong Paul Olarig, which was filed Apr. 22, 2002 and which is incorporated herein by reference in its entirety for all purposes.

### FIELD OF THE INVENTION

The present application is related to computer networks. More specifically, the present application is related to a system and method for a scalable switch fabric for use in computer networks.

### BACKGROUND OF THE INVENTION TECHNOLOGY

Current storage area networks (“SANs”) are designed to carry block storage traffic over predominantly Fibre Channel (“FC”) standard medium and protocols. FC SANs are local networks that are equivalent to many common types of local area networks (“LANs”) used in standard data communications networks. Expansion of SANs is limited in that conventional FC SANs cannot be implemented over geographically distant locations. Conventional FC architecture is not suitable for most wide area networks (“WANs”) or metropolitan area network configurations. While TCP/IP and Ethernet may be used to implement block storage protocols over a WAN/LAN, these two protocols are not efficient for block storage applications. Accordingly, current SANs are limited to a single geographic location.

There exist several proposals for moving block storage traffic over SANs built on other networking medium and protocol technologies such as Gigabit Ethernet, ATM/SONET, Infiniband, and the like. Presently, to bridge or interconnect storage data traffic from SANs using one medium/protocol type to another SAN using an incompatible protocol/medium type requires devices and software that perform the necessary protocol/medium translations. These translation devices, hereinafter referred to as “translation bridges,” make the necessary translations between incompatible protocol/mediums in order to serve the host computers/servers and storage target devices (the “clients”). Interconnecting heterogeneous SANs that may be easily scaled upward using these translation bridges is very difficult because the translation bridges usually become the bottleneck in speed of data transfer when the clients (servers and/or storage devices) become larger in number. In addition, in a mixed protocol environment and when the number of different protocols increase, the complexity of the software installed on the translation bridges increases, which further impacts performance.

Other limitations of the size of SANs, in terms of storage capacity, are cost and manpower. In order to expand the storage capacity of a SAN, storage devices such as disk drives, controllers, fiber channel switches and hubs, and other hardware must be purchased, interconnected and made functionally operable together. Another major, if not primary, expense is the cost of managing a SAN. SAN management requires a great deal of manpower for maintenance and planning. For example, as storage capacity grows, issues such as determining server access to storage devices, backup strategy, data replication, data recovery, and other considerations become more complex.

It is desirable that next generation storage network switch systems may have ingress and egress ports that support different protocols and network media so that different types of host computer/servers and storage target devices may be attached directly to the switch system and start communicating with each other without translation overhead. In order to communicate between any two ports, the source and destination ports must be identifiable in both the source and destination protocol. For example, to send a message or frame from a FC port to a Gigabit Ethernet port, the destination port needs to appear as a FC port to the connected FC source, and the source port needs to appear as a Gigabit Ethernet port to the destination port.

What is needed is a storage network switching device that performs a multiplicity of functions and has a multiplicity of port types to allow it to connect to a variety of network types (e.g., FC, Gigabit Ethernet, etc.) in a SAN and/or LAN and/or WAN environment.

### SUMMARY OF THE INVENTION

The invention overcomes the above-identified problems as well as other shortcomings and deficiencies of existing technologies by providing a storage network device that performs a multiplicity of functions and has a multiplicity of port types to allow it to connect to a variety of network types (e.g., Fibre Channel, Gigabit Ethernet, etc.). A primary function of the invention is to act as a storage network switch where frames are switched from port to port. However, because of its architecture, the present invention has the ability to perform many additional functions that take advantage of its high performance, highly scalable, and highly programmable infrastructure. The switch architecture of the present invention is comprised of: 1) a Switch Fabric Subsystem (“SFS”); 2) I/O Subsystems (“IOS”); 3) Application Subsystems (“AS”); and 4) System Control Subsystems (“SCS”).

The SFS is a protocol agnostic cell or packet switching infrastructure that provides the high performance and highly scalable interconnections between the IOSs and ASs. It provides primary data paths for network traffic being moved by the switch. The IOSs provide the actual port connectivity to the external network devices that use the switch to communicate with other external network devices. The IOSs are part of the data path and are responsible for making the high performance, low level decoding of ingress frames from the external ports; and switching/routing, identifying the destination IOS for the frame, and queuing the frame for transmission through the Switch Fabric. The IOSs process packets at the very lowest protocols levels (Data Link and Network Layer of the OSI Model) where fast switching and routing decisions can be made. The ASs provide the platform with higher levels of processing of frames and data streams in the switch system. The ASs have more advanced programmability and functionality than the IOSs, but rely on the control and data information provided by the IOSs to maintain high performance packet throughput. Typical applications that can run on the ASs are caching, storage virtualization, file serving, and high level protocol conversion. The SCSs provide the overall management of the storage network switch. Most of the low level switching and routing protocol functions are executed on the SCSs. In addition, management access functions such as the standard simple network management protocol (“SNMP”) agent, web server, Telnet server, and the direct command line interface reside on the SCSs. The hardware and software executing on the SCSs are responsible for managing the other subsystems in the Storage Network Switch 100.

The present invention is directed to a storage network switch, comprising: a switch fabric subsystem; an input-output subsystem coupled to said switch fabric subsystem; an application subsystem coupled to said switch fabric subsystem; and a system control subsystem coupled to said switch fabric subsystem, said input-output subsystem and said application subsystem.

The present invention is also directed to a scalable switch fabric system for computer networks, said system comprising: at least one input-output subsystem coupled to at least one computer network; a switch fabric subsystem coupled to said at least one input-output subsystem; an application subsystem coupled to said switch fabric subsystem; and a system control subsystem coupled to said switch fabric subsystem, said input-output subsystem and said application subsystem.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a conceptual schematic system architecture of a Storage Network Switch 100, according to an exemplary embodiment of the present invention;

FIG. 2 is a conceptual schematic block diagram of a switch device used in the Storage Network Switch 100 of FIG. 1;

FIG. 3 is a schematic block diagram of a switch fabric configuration that utilizes multiple links according to the present invention;

FIG. 4 is a schematic block diagram of a more complex switch fabric configuration that illustrates the scalability of the SFS of the present invention;

FIG. 5 is a schematic block diagram of an exemplary embodiment of an architecture of an IOS for the storage network switch, according to the present invention;

FIG. 6 is a schematic block architecture of a network processor (“NP”), according to an exemplary embodiment of the present invention;

FIG. 7 is a schematic block diagram of an exemplary embodiment of an application subsystem (“AS”) of the present invention;

FIG. 7a is a schematic block diagram of an exemplary embodiment of a portion of an AS of the present invention;

FIG. 8 is a schematic block diagram of another exemplary embodiment of an AS of the present invention;

FIG. 9 is a schematic block diagram of an exemplary embodiment of the redundancy control system of the present invention;

FIG. 10 is a schematic block diagram of the flow of data through an exemplary embodiment of the present invention;

FIGS. 11, 12, and 13 are schematic block diagrams illustrating the control of flow through an exemplary embodiment of the present invention;

FIG. 14 is a schematic of a high-level application flow diagram, according to an exemplary embodiment of the present invention;

FIG. 15 is a schematic block diagram of the flow of application information through an exemplary embodiment of the present invention;

FIGS. 16a-16f are block diagrams of various embodiments of the control path of the present invention;

FIGS. 17a-17d are block diagrams further illustrating various details of the embodiments of the control paths according to FIG. 16;

FIGS. 18a and 18b are flow charts illustrating the various embodiments of the control path and the data path according to the method of the present invention;

FIG. 19 is a flow chart illustrating the egress path according to the method of the present invention;

FIG. 20 is a flow chart illustrating the application path according to the method of the present invention;

FIG. 21 is a flow chart illustrating the function of the System Control Processor according to the method of the present invention;

FIG. 22 is a flow chart illustrating the control path and the data path according to the method of the present invention;

FIG. 23 is a flow chart illustrating the application control process according to the method of the present invention;

FIG. 24 is a flow chart illustrating the application command processing method of the present invention; and

FIG. 25 is a flow chart illustrating the application response processing method according to the present invention.

The present invention may be susceptible to various modifications and alternative forms. Specific exemplary embodiments of the present invention are shown by way of example in the drawings and are described herein in detail. It should be understood, however, that the description set forth herein of specific exemplary embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

The present invention is directed to a storage network device that performs a multiplicity of functions and has a multiplicity of port types to allow it to connect to a variety of network types (e.g., FC, Gigabit Ethernet, etc.). A primary function of the invention is to act as a storage network switch wherein frames are switched from port to port. However, because of its architecture, the present invention has the ability to perform many additional functions that take advantage of its high performance, highly scalable, and highly programmable infrastructure. The present invention is also useful for peer-to-peer networks as a simple switch where all attached devices are direct end devices, because the functions provided by the application blade of the architecture provide significant functionality even in the simple peer-to-peer network. Specifically, the cache feature alone provides a tremendous competitive advantage over other switch implementations.

For purposes of this disclosure, an application blade can be any electronic device that is able to perform one or more functions. For example, the application blade may be a peripheral card that is connected to a server or other device that is coupled to the switch of the present invention. Other examples of application blades include: remote computing devices that are coupled to the present invention by a network connection; or software processes running virtually on a single or multiprocessing system and/or single or multithreading processor; or electronic appliances with specific functionality; or the like.

The following description of the exemplary embodiments of the present invention contains a number of technical terms using abbreviations and/or acronyms which are defined herein and used hereinafter:

TABLE 1

| | |
|---|---|
| ANB | Application North Bridge |
| AP | Application Processor |
| AP | Application Card Processor |
| AS | Application Subsystem |
| BMC | Buffer Management Coprocessor |
| EMU | Environmental Monitoring Units |
| FC | Fibre Channel |
| FCP | Switch Fabric Coprocessor |
| FIOC | Fabric I/O Controller |
| FP | Fabric Coprocessor |
| Gb/s | gigabits per Second |
| I/O | Input/Output |
| IOP | Input/Output Processor |
| IOS | I/O Subsystem |
| IPC | Interprocessor Communications |
| LCP | Line Card Processor |
| MAC | Media Access Control |
| North Bridge | Combination Memory Controller and I/O |
| | Bus Bridge |
| NP | Network Processor(s) |
| PAB | Port Aggregation Bridge |
| PCI | Peripheral Component Interconnect |
| QMC | Queue Management Coprocessor |
| RCL | Redundancy Control Logic |
| SAN | Storage Area Network |
| SCC | System Control Cards |
| SCP | System Control Processor |
| SCS | System Control Subsystem |
| SERDES | External Serializer/Deserializer |
| SFBI | Switch Fabric Bus Interface |
| SFC | Switch Fabric Controller |
| SFCP | Switch Fabric Coprocessor |
| SFI | Switch Fabric Interface |
| SFPC | Switch Fabric Path Control |
| SFS | Switch Fabric Subsystem |
| SNMP | Simple Network Management Protocol |
| SNS | Storage Network Switch |
| TLC | Table Look-up Coprocessor |
| XCP | Executive Coprocessor |

Referring now to the drawings, the details of an exemplary specific embodiment of the invention is schematically illustrated. Like elements in the drawings will be represented by like numbers, and similar elements will be represented by like numbers with a different lower case letter suffix.

Storage Network Switch System

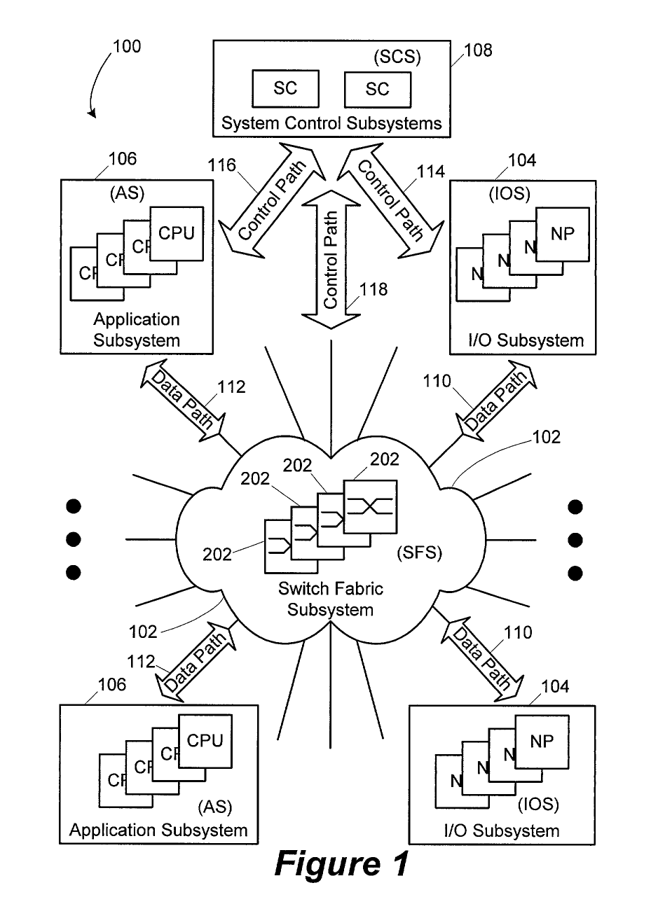

FIG. 1 illustrates a conceptual schematic system architecture of a storage network switch, according to an exemplary embodiment of the present invention. The Storage Network Switch, generally represented by the numeral 100, comprises: 1) a SFS 102, 2) IOSs 104, 3) ASs 106, and 4) SCSs 108. The SFS 102 is a protocol agnostic cell or packet switching infrastructure that provides the high performance and highly scalable interconnections between the IOSs 104 and ASs 106. It provides primary data paths 110, 112 for network traffic being moved by the Storage Network Switch 100. The IOSs 104 provide the actual port connectivity to the external network devices that use the Storage Network Switch 100 to communicate with other external network devices (not illustrated). The IOSs 104 are part of the data paths 110 and are responsible for making the high performance, low level decoding of ingress frames from the external ports; and switching/routing, identifying the destination IOS 104 for the frame, and queuing the frame for transmission through the SFS 102. The IOSs 104 process packets at the very lowest protocols levels (Data Link and Network Layer of the OSI Model) where fast switching and routing decisions can be made. The ASs 106 provide the platforms for higher level processing of frames and data streams in the Storage Network Switch 100. The ASs 106 have more advanced programmability and functionality than the IOSs 104, but rely on the control and data information provided by the IOSs 104 to maintain high performance packet throughput. Typical applications that can run on the ASs 106 are caching, storage virtualization, file serving, and high level protocol conversion. The SCSs 108 provide the overall management of the Storage Network Switch 100. Most of the low level switching and routing protocol functions are executed on the SCSs 108. In addition, management access functions such as the SNMP agent, web server, Telnet server, and the direct command line interface reside on the SCSs 108. The hardware and software executing on the SCSs 108 are responsible for managing the other subsystems (102, 104, 106) in the Storage Network Switch 100. Switch Fabric Subsystem

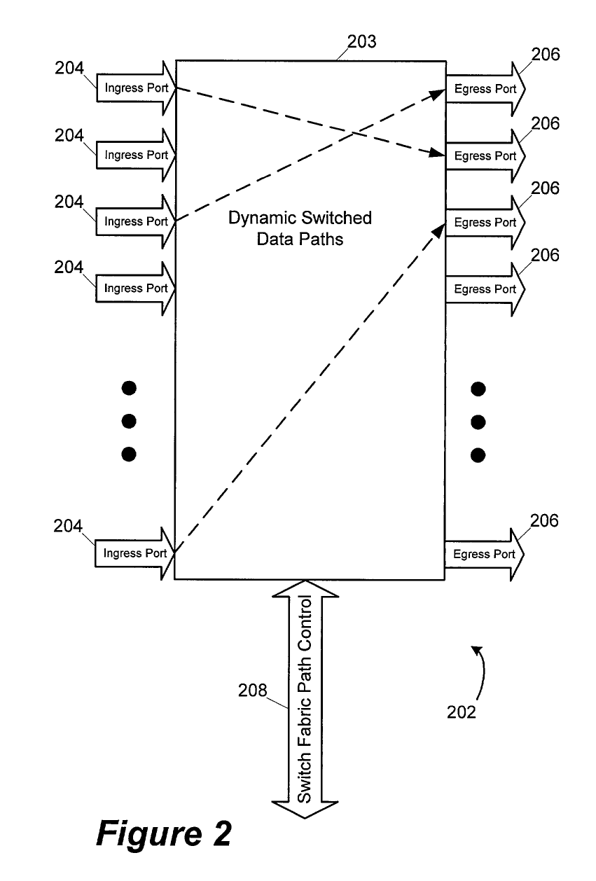

The SFS 102 is designed to provide very high levels of performance and scalability. Switch fabrics are built using a series of switch fabric devices which may be highly integrated semiconductor devices in an integrated circuit die or chip. For highly scalable systems, typically cross bar switch devices are used, but other types (such as shared memory devices) can be used as well. FIG. 2 depicts a conceptual block diagram for one of the switch devices in the SFS 102. The switch fabric device is generally indicated by the numeral 202, and has a plurality of ingress ports 204 and a plurality of egress ports 206 at opposite ends of dynamic switched data paths 203, which may be used for connection to the IOSs 104 and ASs 106. Typically, one ingress port 204 and one egress port 206 are paired together to communicate to a single IOS 104 or AS 106. In smaller switch configurations, several of these pairs of ingress ports 204 and egress ports 206 can be connected to the same IOS 104 or AS 106 for redundancy and load balancing purposes.

Each ingress port 204 and egress port 206 of a switch fabric device 202 is typically implemented as a high-speed differential signal port. Some switch fabric devices 202 may have a differential transmitter and receiver integrated into the device and drives/receives these differential signals directly. Some switch fabric devices 202 may use a parallel 5-bit or 10-bit interface and an external serializer/deserializer (“SERDES”) to convert the parallel signals to differential signals. The raw transfer rate of these ports varies, but state of the art today is 1.25 Gb/s to 3.125 Gb/s. Since one ingress port 204 and one egress port 206 are usually paired together, transceivers are used that have a receive (ingress) differential pair of signals and an output (egress) differential pair of signals. This differential signal technology may be the same technology typically used for Gigabit Ethernet, FC, or other high speed physical communications interfaces presently used in industry.

In addition to the data path ingress port(s) 204 and the data path egress port(s) 206, each switch fabric device 202 typically has one or more Switch Fabric Path Control (“SFPC”) ports 208 that may be used to configure the switch fabric device 202. The SCSs 108 typically are used to drive the control ports if they exist. The configuration logic for the switch fabric device 202 may comprise enabling and disabling ports, reading error or statistics registers from the switch fabric device 202, and setting parameters for the behavior of the switch fabric device 202 upon receiving specific frame or cell types from the ingress ports 204 (e.g., multicast or broadcast configuration). Some of the switch fabric devices 202 may allow the control function to occur in-band via the ingress/egress port pairs (204, 206) as well by specifying certain specific control messages that may be sent and that are not typically forwarded by the switch fabric device 202 in normal operation. These control messages may be processed internally by the switch fabric device 202, after which a response message by the switch fabric device 202 may be sent via the egress port 206 paired with the ingress port 204 from which the control message was received.

Each switch fabric device 202 has a multiplicity of ingress ports 204 where frames or cells are received from an ingress IOSs 104 and/or ASs 106. In addition, these ingress ports 204 can also receive routing information from the IOSs 104 and/or ASs 106 which is used by the switch fabric devices 202 for dynamically allocating ingress to egress switch paths/resources internal to the switch fabric devices 202. For example, when an IOS 104 needs to forward a frame or cell to another subsystem (IOS 104 or AS 106), it must send a request to the attached switch fabric device(s) specifying the desired egress port 206 to which it needs to send the frame or cell. The switch fabric device 202 may check to see if the requested egress port 206 is currently busy. Once the requested egress port 206 is available for use, the switch fabric device 202 may grant the request by sending a grant message back to the requesting IOS 104 via the egress port 206 that is paired with the ingress port 204 from which it received the original request message. Upon receiving the grant message, the IOS 104 may send the frame or cell to the switch fabric device 202 via the ingress port 204 in the switch fabric device 202 and the switch fabric device 202 may then forward the frame or cell to the reserved egress port 206. After the frame or cell has been forwarded, the egress port 206 is released for use by the next requesting ingress port 204.

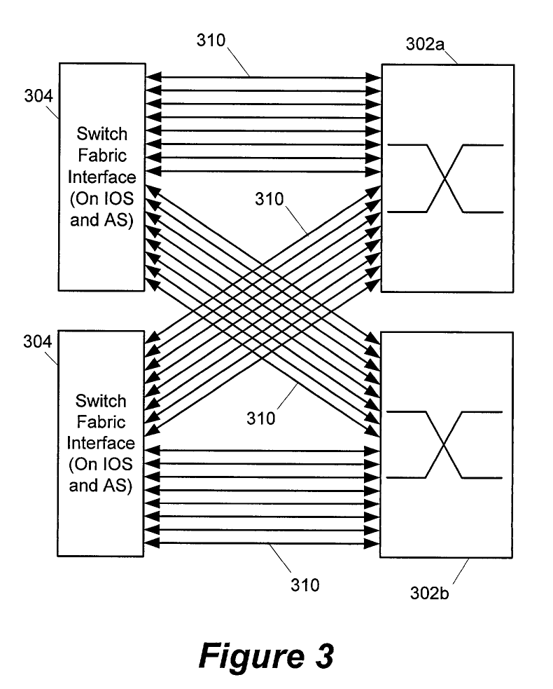

Typically, switch fabric devices 202 are designed to be scalable so that small switch configurations can be built using one or more integrated circuits comprising a plurality of switch fabric devices 202. As additional port count, bandwidth or capacity is needed, several switch fabric devices 202 may be used in parallel to add capacity and redundancy to the overall SFS 102. FIG. 3 illustrates a switch fabric configuration that utilizes multiple links (each link 310 indicates signal paths that connect egress ports 206 and ingress ports 204) between the IOSs 104 or ASs 106 and the switch fabric devices 202 in the SFS 102. On each IOS 104 and AS 106, there exists a component called a Switch Fabric Interface (“SFI”) 304. The SFI 304 has a plurality of ingress/egress ports similar to those on the SFS 102. These SFI ports may be connected to the same switch fabric device 202, or may be evenly distributed between multiple switch fabric devices 202. In the exemplary embodiment illustrated in FIG. 3, each connection between an IOS 104 and a switch fabric device 202 represents a transceiver connection (310) wherein an egress port 206 on the IOS 104 is connected to an ingress port 204 of the switch fabric device 202, and an ingress port 204 on the IOS 104 is connected to the egress port 206 of the switch fabric device 202. Because there are preferably only two switch fabric devices 302a and 302b that make up the SFS 102, this may be classified as a small switch fabric. In the exemplary embodiment illustrated in FIG. 3, each IOS 104 may have 16 ingress/egress port pairs, however, it is contemplated and within the scope of the present invention that any number of ingress/egress port pairs may be used as illustrated and described herein. In the exemplary embodiment illustrated in FIG. 3, switching bandwidth and redundancy may be maximized in each IOS 104 by connecting, for example, but not limited to, eight (8) of its port pairs to each of the two (2) switch fabric devices 302a and 302b. The IOSs 104 can maximize the redundant links to the switch fabric devices 302a and 302b by sending and receiving frames or cells of data across all port pairs simultaneously. If a connection between the IOS 104 and the switch fabric device 202 fails, the SFI 304 on the IOS 104 and the switch fabric devices 202 may disable their port pairs and use the remaining connections to transfer the data. If an entire switch fabric device 202 fails, the SFI 304 on the IOS 104 can disable all port pairs connected to the failed switch fabric device 202 port (e.g., ingress port 204 or egress port 206) and may thereby continue to transfer data through a good switch fabric device 202. Therefore, the present invention provides fault protection against link/connection failures and device failures.

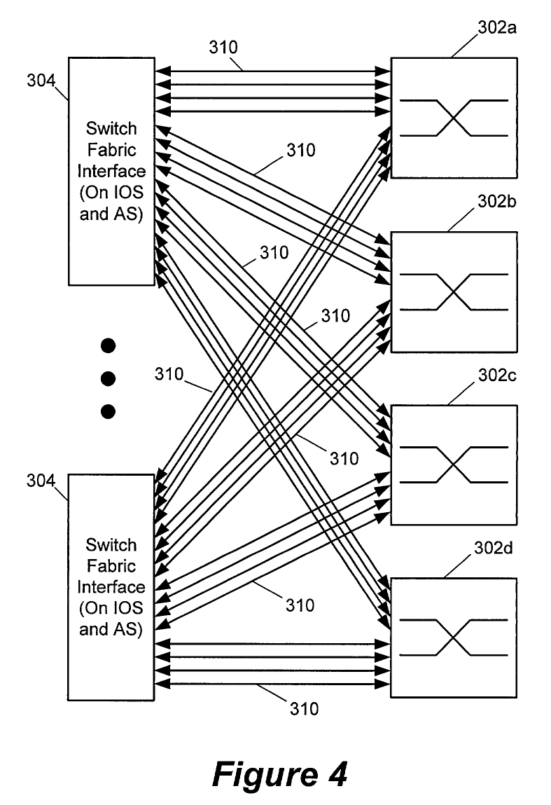

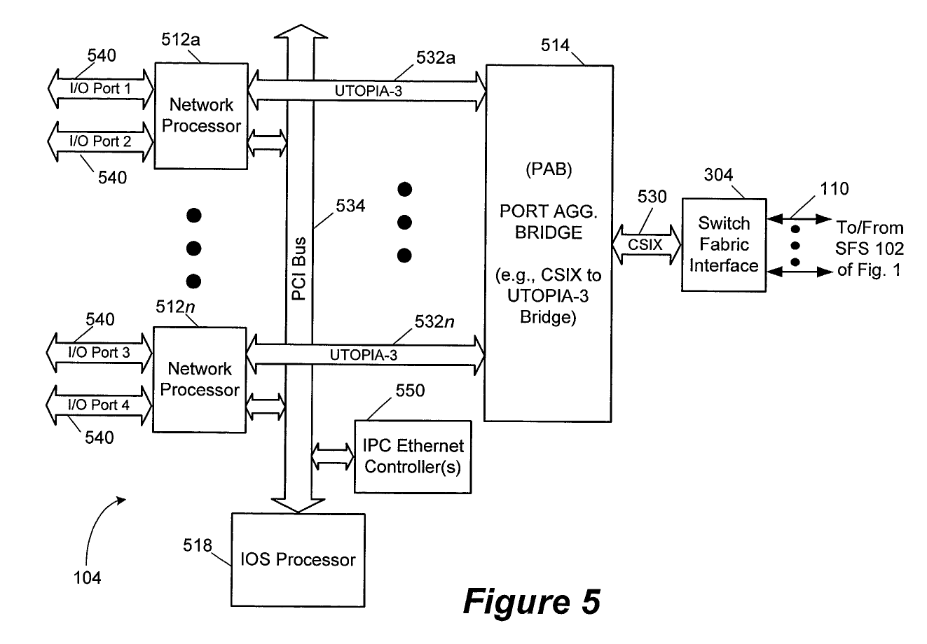

FIG. 4 illustrates a more complex switch fabric configuration that illustrates the scalability of the SFS 102. In this exemplary embodiment, the number of switch fabric devices 302a, 302b, 302c and 302d have been expanded to four.

I/O Subsystem

The IOS 104 is designed to provide the physical port connectivity to the Storage Network Switch 100. The IOS 104 provides the high performance data path 110 between the external switch ports and the SFS 102. The IOS 104 preferably performs a multiplexing/demultiplexing or port aggregation function for the Storage Network Switch 100. In other words, the external switch ports may be lower bandwidth ports than the internal interface to the SFS 102. For example, typical external port speeds are 1 Gb/s for Gigabit Ethernet or FC. There is also a 2 Gb/s version of FC available as well. Typical bandwidths available for the switch interface to the SFS 102 are 12.5 to 25 Gb/s or greater. Therefore, an IOS 104 typically implements a plurality of external I/O ports 540 and aggregates the ingress traffic and de-multiplexes the egress traffic between them and the high bandwidth SFI 304 to the SFS 102. FIG. 5 is a schematic block diagram of an exemplary embodiment of an architecture of an IOS 104 for the Storage Network Switch 100. The IOS 104 comprises: 1) one or more NPs 512; 2) at least one Port Aggregation Bridge (“PAB”) 514; 3) at least one SFI 304, and 4) at least one IOS processor 518. The interprocessor communications (“IPC”) Ethernet controllers 550 may be connected to the IOS processor 518 for IPC-type communications with the other subsystems that comprise the storage network switch 100. In another exemplary embodiment of the present invention, redundancy control techniques may be employed to enhance fault tolerance and scalability.

Network Processors

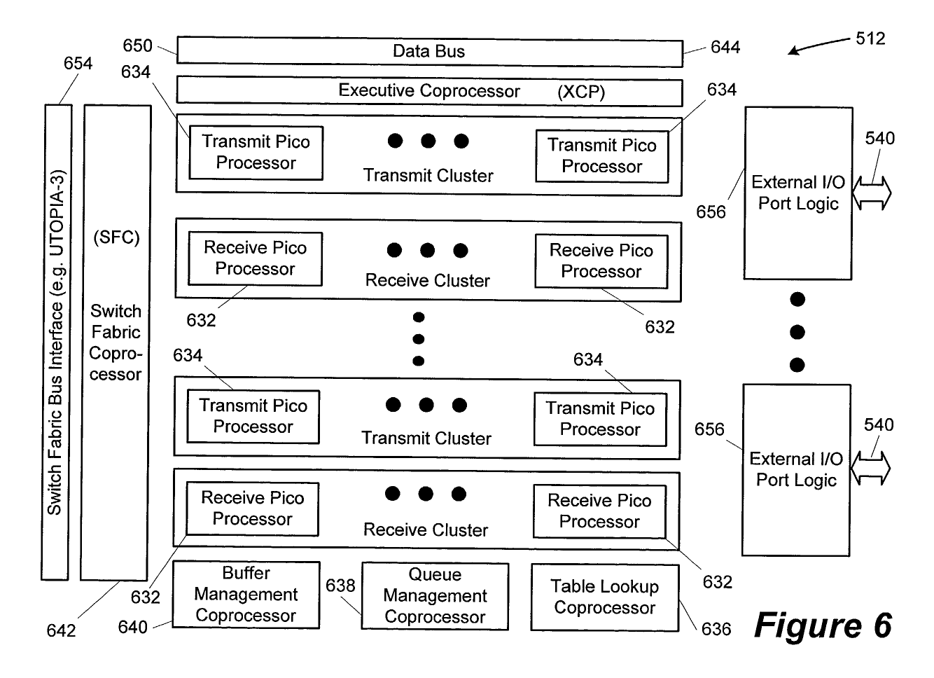

Referring to FIG. 6, a schematic block architecture of an NP 512 is illustrated, according to an exemplary specific embodiment of the invention. The NPs 512 are powerful but low level processors that provide at least one external port for the Storage Network Switch 100 and one switch fabric port to interface with the internal switch fabric of the Storage Network Switch 100. Preferably, these NPs 512 may support from 1 to 10 external 1 Gb/s, 2 Gb/s, or 10 Gb/s ports. In a preferred exemplary embodiment, the NPs 512 can support multiple frame or cell level protocols such as Gigabit Ethernet, 10 Gb/s Ethernet, 1 Gb/s FC, 2 Gb/s FC, SONET OC-3, SONET OC-12, SONET OC48, etc. The NP 512 may be comprised of a plurality of high performance picoprocessors (transmit 634 and receive 632) that have limited instruction sets relative to a standard general purpose processor. In addition to a plurality of picoprocessors 632, 634, an NP 512 may also have a set of special purpose coprocessors for performing table look-ups, queue management, buffer management and interfacing to the switch fabric, e.g., Table Look-up Coprocessor (“TLC”) 636, Queue Management Coprocessor (“QMC”) 638, Buffer Management Coprocessor (“BMC”) 640 and Switch Fabric Coprocessor (“FCP”) 642, respectively. An NP 512 may also have an Executive Coprocessor (“XCP”) 644 that may handle general management of the NP 512, software downloads, and interfacing to external processors via data bus 650. Data bus 650 may be any type of data bus or data transmission device including, but not limited to, PCI and the like.

Picoprocessors

The receive picoprocessors 632 and transmit picoprocessors 634 within the NP 512 may have special instructions and coprocessors included to help provide high performance parsing and classification of the frames or cells being transmitted or received on the external I/O ports 540 that are coupled to the NPs 512. When a frame is received by an external port 540 of the NP 512, it is preferably processed by one of a number of picoprocessors dedicated to processing incoming frames on that port. There may be, for example, four receive picoprocessors 632 allocated to handling receive frames from a particular external port 540. As each frame is received from the network attached to that I/O port 540, the NP 512 may assign the processing of that frame to one of the allocated receive picoprocessors 632 in a round robin fashion. Likewise, when a frame is forwarded to the NP 512 from the SFS 102 to be transmitted out one of its external I/O ports 540, it may receive the frame from the fabric through a SFC 642, wherein the frame may be processed in a round robin fashion by one of the transmit picoprocessors 634 allocated for handling transmit traffic for that external I/O port 540. By allowing multiple picoprocessors to process frames for a single I/O port 540, the picoprocessors 632, 634 have more time to classify a frame and to make the proper routing decisions.

The receive picoprocessors 632 may extract various fields in the received frames and make use of the TLC(s) 636 in the NP 512 to use the extracted fields to look-up the route information for that received frame. For example, the Ethernet address or FC address of an incoming frame can be extracted and sent to a TLC 636 to search a route table for the destination (egress) port identifier to which to send the frame. The receive picoprocessors 632 may then use the results of the table look-up to send the frame to the QMC 638 for queuing either to the SFC 642 for forwarding through the switch fabric in the SFS 102, or to the XCP 644 if it is a control frame that needs to be processed by a particular process in the IOS 104. This low level frame parsing and table look-up processing enables the receive picoprocessors 632 to perform fairly sophisticated frame route processing while maintaining the ability to process frames while receiving them at the fastest possible line rates. Not only can the receive/transmit picoprocessors 632, 634 route frames based on address fields found in the frame headers, but they can also make routing decisions on any of the data in the frame. This allows the software programmed in the picoprocessors 632, 634 to direct and control sophisticated frame routing based on frame types, contents of the frame, or control fields in the frame. In addition, the picoprocessors 634, 632 are also able to modify frames as they are sent or received from the external I/O ports 540 in order to attach the appropriate route information into the frame or to add control information as the frame is going to the SCS 108 or an AS 106.

The transmit picoprocessors 634 accept frames forwarded from the SFC 642 that were sent to the NP 512 from the SFS 102. The transmit picoprocessors 634 are allocated in groups of four, preferably, to handle sending frames out a particular egress I/O port 540. The transmit picoprocessors 634 may process the frames received from the SFC 642 in a round robin fashion similar to the manner the receive picoprocessors 632 handle ingress frames from the external I/O ports 540. The transmit picoprocessors 634 may perform a Cyclic Redundancy Check (“CRC”) checksum calculations on the frames and modify other fields necessary for the proper transmission of the frame to the associated external I/O port 540. Finally, when the transmit picoprocessors 634 have completed their processing of the egress frame, they may queue the frame to the I/O port interface logic 656 for actual transmission on the external I/O port 540.

Table Look-Up Coprocessor

The TLC 636, as mentioned herein, may be a common coprocessor that is shared by the picoprocessors 632, 634 within the NP 512. The picoprocessors 632, 634 send look-up requests to the TLC 636 whenever they have information that needs to be looked up in a table maintained in table look-up memory (not illustrated). The TLC 636 does not manage the tables in memory, it simply performs the look-up operation itself. The XCP 644 or the IOS processor 518 may initialize, update, and/or maintain the tables stored in table look-up memory. The table look-up memory is typically very fast memory attached to the NP 512 via a high performance bus dedicated to connecting the look-up memory to the NP 512.

### Buffer Management Coprocessor

The BMC 640 is a common coprocessor that manages the buffer memory (not illustrated) used to store temporarily frame or cell data as the NP 512 processes the ingress and egress frames. As the picoprocessors 632, 634 process ingress frames received from the external I/O ports 540, the BMC 640 is taking the frames and storing them into memory. After the frames have been received, and the receive picoprocessors 632 have completed the frame routing look-ups, the receive picoprocessors 632 create a descriptor that points to the buffer memory used to receive the frame and pass it to the QMC 638 to be queued to the appropriate coprocessor for forwarding to the XCP 644, or to the SFC 642. The software running on the picoprocessors 632, 634 allocates the buffer space used by the BMC 640 for receiving the frame/cell data. After frame reception is complete, the software then allocates the queue descriptor from the QMC, and initializes the descriptor with the buffer memory location, the destination coprocessor information, and the final destination information (like final I/O port location). Then the picoprocessor 632 or 634 queues it back to the QMC 638 to indicate the data is ready to be processed by the next XCP 644. Likewise, when a frame is forwarded to the NP 512 for transmission to one of the external I/O ports 540, the BMC 640 may move the frame data into buffer memory while the SFC 642 determines to which port to send the frame. After the frame has been completely moved into buffer memory, the SFC 642 may build a descriptor and queue it to the QMC 638 to pass it to one of the transmit picoprocessors 634 for transmission of the frame through an egress I/O port 540.

### Queue Management Coprocessor

The QMC 638 is a common coprocessor that is used to manage a set of descriptors in a dedicated descriptor memory attached to the NP 512. The descriptors provide information about the contents and length of the cells or frames in the buffer memory of the NP 512. The QMC 638 may manage all queues of the NP 512 in its attached queue memory. The picoprocessors and coprocessors of the NP may allocate and initialize the descriptors. After determining the proper destination device within the NP 512 (i.e., XCP 644, SFC 642, picoprocessors 634, etc.) the picoprocessor or coprocessor may send the descriptor to the QMC 638 indicating the target queue to place the descriptor. Likewise, when a picoprocessor or coprocessor is ready to process a frame from a queue, it may send a request to the QMC 638 to fetch the next descriptor that belongs to its queue. When the use of the descriptor is complete, the owning picoprocessor or coprocessor may send a request to the QMC 638 to free the descriptor for later reuse.

### Switch Fabric Coprocessor

The SFC 642 may be a common coprocessor that is responsible for sending and receiving frames or cells to/from the fabric interface of the NP 512. Typically, the switch fabric bus interface 654 is a high bandwidth bus, e.g., UTOPIA-3, CSIX, SPI-4, etc. The switch fabric bus interface 654 is used to send frames or cells to other NPs 512 in the system via the SFS 102. For frame based protocols like FC or Ethernet, the SFC 642 can segment the frames into cells for transmission to the switch fabric if the switch fabric devices 202 require cell based operations. Some switch fabric devices allow full frame based operation and in these cases, the SFC 642 merely manages the data flow to and from the switch fabric and the internal buffer memory (not illustrated). Many switch fabric devices are designed to switch cells much more efficiently than entire frames; therefore, most NPs 512 support frame to cell segmentation and reassembly. Likewise, the SFC 642 may receive cells from the switch fabric bus interface (“SFBI”) 654 and reassemble them into a frame as it moves the frame data into the buffer memory. To perform this cell segmentation and reassembly process, the SFC 642 builds cells that have a cell header and a cell payload (data). The SFC 642 creates the header based on information provided to it by the picoprocessor or coprocessor that built the descriptor that was queued to the SFC 642. The cell header may contain an indication if the cell is the start of a frame, middle of a frame, or the last cell in a frame. In addition, the cell header may contain information regarding the target IOS 104, NP 512, and I/O port 540 to which the frame is to be forwarded.

Preferably, the SFC 642 has the ability to support flow control mechanisms in cooperation with the attached switch fabric devices, as well as to support flow control mechanisms between itself and other NPs 512 attached to the SFS 102 (either on an associated IOS 104 or another IOS 104 installed in the storage network switch). Local flow control signals are employed between the SFC 642 and the PAB 514 in the exemplary embodiment of the present invention. These local flow control signals can be specific hardware signals on the bus (e.g., UTOPIA-3), or they may be a bit in every cell header transmitted and received from an attached device, e.g., over the CSIX bus 530. In the latter case, where flow control information is passed in the cell headers, flow control information can still be passed even if no data is transmitted across the bus. If the devices have no frame or cell data to send, they will send an idle cell that indicates no data, however, control information in the cell header is still valid. In this manner, flow control mechanisms work even if no data frames or cells are being sent on the bus. Whenever the SFC 642 detects that it does not have enough buffer memory to continue to receive frames/cells from the PAB 514, it may assert its local flow control signal to the PAB 514. The PAB 514 detects the flow control signal and then stops sending cells to the SFC 642 until enough buffers have been made available in the buffer memory to continue to receive frames/cells from the PAB 514. Likewise, if the PAB 514 does not have enough buffer space to accept frames/cells from the SFC 642, it may assert its flow control signal indicating a congestion condition and the SFC 642 may discontinue sending frames/cells to the PAB 514 until the PAB 514 releases the flow control signal.

### Executive Coprocessor

The XCP 644 is a common coprocessor that is responsible for handling generic device functions like initialization, management, and control. Typically, the XCP 644 is the first processor initialized in the NP 512 and is responsible for initializing the remaining coprocessors (e.g., 636, 638, 640 and 642) and picoprocessors (e.g., 632 and 634) in the NP 512. In addition, the XCP 644 may provide the interface function to externally control processors in the Storage Network Switch 100. The physical interface between the XCP 644 and external processors is preferably a PCI bus 650, however, other bus interfaces are contemplated and within the scope of the present invention. The external IOS Processor 518 may communicate through the PCI bus 650 to send commands and control frames to the XCP 644 for transmission through the external I/O ports 540 in the NPs 512. Likewise, control frames received by the external I/O ports 540 are forwarded to the XCP 644 for relay to an IOS Processor 518 via the PCI bus 650. The message/frame passing mechanism may be preferably implemented as a bus master type interface, or it may be implemented as a slave interface function in the XCP 644. The IOS Processor 518 and the XCP 644 may also work together to manage the routing tables that are maintained in the TLC's 636 memory associated with the XCP 644. As the routing protocols in the IOS Processor 518 determine the latest and best routing paths through the network, the updated routing table entries are sent to the NP's 512 XCP 644 (via the PCI bus 650) for placement into the table look-up memory (not illustrated).

The XCP 644 may also control the port state of each port controlled by the picoprocessors 632, 634. When the exemplary embodiment of the present invention wants to shut down or disable ports, an IOS Processor 518 may send commands to the XCP 644 (via the PCI bus 650) to disable, control, change modes, or enable the I/O ports 540 as necessary. The XCP 644 communicates the control information to the picoprocessors 632, 634 that control the ports 540 or may directly control the port states thereof. In addition, the XCP 644 is preferably responsible for maintaining statistics about the overall operation of the NPs 512. The NP's 512 statistics may include, but are not limited to, transmission and reception statistics, error counts, mode change logs, control frame statistics, and current state information. The XCP 644 may report these statistics to the IOS Processor 518 for reporting to external network management systems.

### Port Aggregation Bridge

Referring to FIG. 5, the PAB 514 provides connections from a high bandwidth bus, e.g., CSIX bus 530 provided by the SFI 304 to lower bandwidth busses, e.g., UTOPIA-3 busses 532 connected to the NPs 512. The CSIX bus 530 is a full duplex bus with separate 64-bit transmit and receive busses operating from about 200 MHz to 250 MHz. The UTOPIA-3 bus 532 is a full duplex bus with separate 32-bit transmit and receive busses operating at or about 100 MHz. A preferred function of the PAB 514 is to provide buffering of data that is received from the CSIX bus 530 and then to forward the cells or frames to the appropriate destination UTOPIA-3 bus 532. Likewise, the buffers in the PAB 514 receive cells or frames from the UTOPIA-3 busses 532, after which the PAB 514 multiplexes these cells or frames to the CSIX bus 530. The PAB 514 maintains transmit and receive buffer space for its CSIX interface as well as for each of its UTOPIA-3 interfaces. The PAB 514 may also participate in the flow control mechanisms provided by the NPs 512 and the SFI 304 connected thereto. If the SFI's 304 receive buffers are nearly full, it may signal the PAB 514 of this condition by either sending a cell on the CSIX bus 530 to the PAB 514 with a cell header bit indicating that a congestion condition exists, or by asserting a special signal directly to NP 512 through the UTOPIA-3 bus 532. When the PAB 514 receives this congestion indication, it preferably will immediately stop sending data to the SFI 304 until the congestion indication has been removed (either by receiving a cell with the congestion header bit turned off or by having its congestion signal deasserted). If cell header information is used for flow control signals, then the devices may use idle cells for communication on control information (e.g., flow control) if no data frames or cells are available for transmission. The preferred method used for congestion/flow control depends on the type of bus being used to attach the PAB 514 to the SFI 304. Likewise, if a receive buffer in one of the NPs 512 attached to one of the UTOPIA-3 busses 532 is near a full state, it may either send a cell onto the UTOPIA-3 bus 532 with a congestion header bit set or assert a congestion signal directly to the PAB 514, wherein the PAB 514 may immediately stop forwarding traffic to the affected NP 512 until the congestion indication is removed.

If the PAB 514 detects that its own CSIX bus 530 receive buffers are getting full, it may assert a congestion indication to the SFI 304. Likewise, if the PAB 514 detects its own receive buffers for one of the UTOPIA-3 busses 532 is almost full, it may assert a congestion condition to the appropriate NP 512. When the buffers drain sufficiently, then the PAB 514 may deassert its congestion indication to the appropriate bus (530 or 532) in order to continue to receive cells or frames from the devices attached to the other end of the respective bus.

### Switch Fabric Interface

The SFI 304 provides a communication path between the high bandwidth CSIX bus 530 and the SFS 102. The SFI 304 may interface to the switch fabric via a multiplicity of high speed serial link pairs (one transmit and one receive link per pair). For smaller switch fabric configurations, several of these link pairs may be connected to each switch fabric device to increase throughput by load balancing the traffic to the switch fabric devices. In larger switch fabric configurations, one link pair preferably may be connected to each switch fabric device. In this manner, by increasing the number of switch fabric devices in the SFS 102 that are operating in parallel, one can increase the number of IOS 104/SFIs 304 that may be attached to the SFS 102. This expansion is illustrated in FIGS. 3 and 4.

The SFI 304 receives cells or frames from the CSIX bus 530 and queues them for transmission to the switch fabric. Once a cell or frame has been queued, the SFI 304 may request a path through the SFS 102 by either using a dedicated control bus to the SFS 102 or, preferably, by sending a special request cell via one of the serial links to the SFS 102. The SFS 102 may acknowledge the request when it has set up a path for the requesting SFI 304 through the switch fabric to the target IOS 104 or AS 106 (and the corresponding destination SFI 304 on that IOS 104 or AS 106).

Likewise, the SFI 304 receives frames or cells through any of its serial links 110 from the SFS 102. The SFI 304 may receive cells or frames simultaneously from all attached serial links 542. One of the primary functions of the SFI 304 is to perform buffering and synchronization of the received cells if cells are used to pass data. This buffering and synchronization operation is necessary in order to ensure that cells do not arrive and get forwarded on the CSIX bus 530 out of order from their original transmission order (if the cells are part of the same frame received from the same IOS). These operations can rely on information in the cell headers to provide unique identification (“ID”) to ensure proper ordering, or the system can rely on strict timing relationships between the serial links (e.g., maximum link lengths, maximum signal skew between links, etc.) and buffer cells in constant time intervals. Once cell order is assured, the SFI 304 queues the cells for transmission to the CSIX bus 530.

Another important function of the SFI 304 is the detection of link errors and balancing the load of cells or frames transmitted to the SFS 102. If a link fault is detected by the SFI 304, it disables transmissions to that link and does not send arbitration requests, cells, or frames on that link until it detects that link state is restored. In addition, the SFI 304 can provide basic quality of service guarantees by queuing and transmitting cells or frames based on priorities. The priorities can be requested by the NP's 512 by placing the requested priority in the cell headers, or by basing the priority on what external I/O ports 540 or NPs 512 the cells or frames are sent from or destined to. The SFI 304 implements a plethora of buffers internally or externally via an external memory. This memory is organized into a set of queues of various priorities that can be used to queue ingress as well as egress data traffic through the SFI 304.

### Application Subsystem (“AS”)

The AS, generally represented by the element numeral 106, provides for the processing of upper layer protocols and applications that the IOS 104 may not be able to handle. The AS 106 has a high performance interface to the switch fabric that implements high performance general purpose processors to provide high levels of functionality for the Storage Network Switch 100. The AS 106 works with the NPs 512 associated with the IOS 104 to help accelerate the processing of frames. The NPs 512 may perform sophisticated frame parsing and routing look-ups. When the NPs 512 determine that a frame needs higher levels of processing, they can either send the frames directly to the AS 106, or they can append additional control information into the frames to help the processor(s) in the AS 106. This technique improves the processing speed of the AS 106 by allowing it to avoid some of the time-consuming low level processing that the NPs 512 have already performed for the AS 106. Therefore, this exemplary embodiment allows the AS 106 to be optimized for upper layer protocol and application processing.

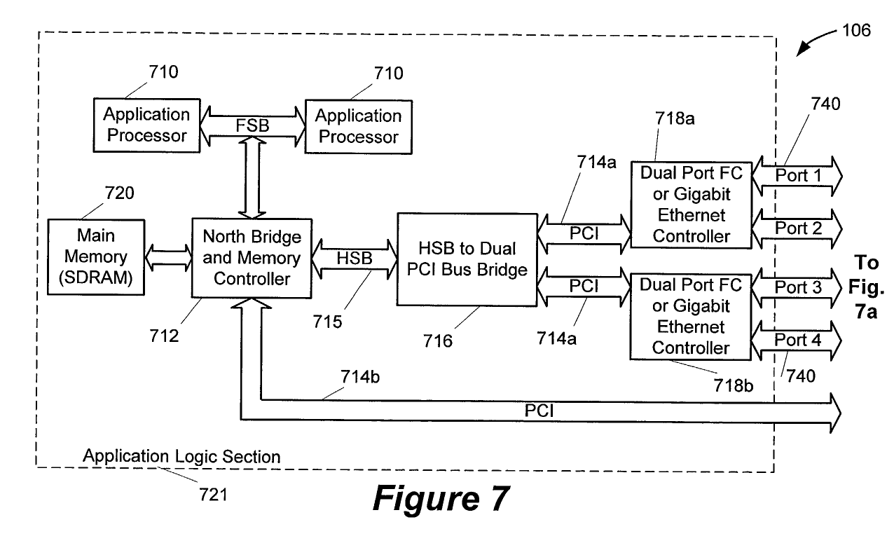

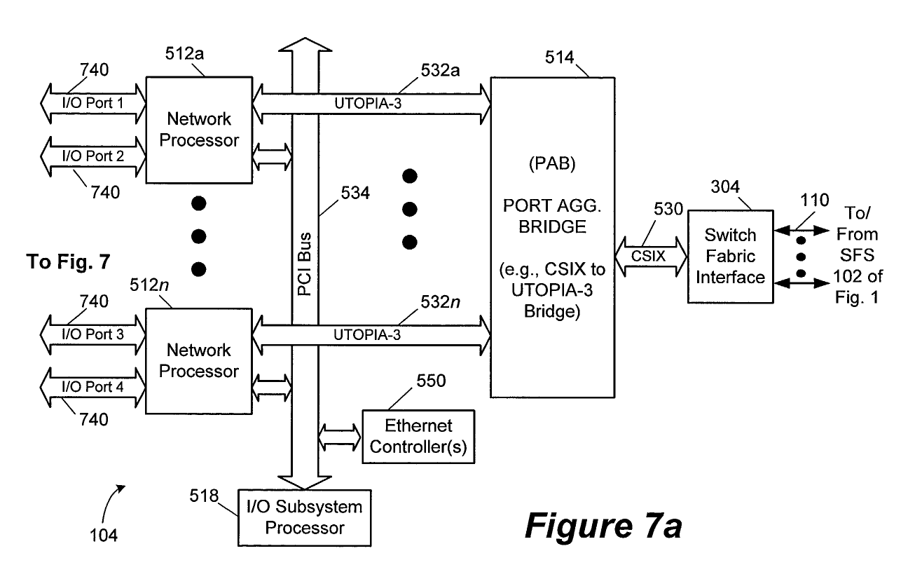

FIG. 7 depicts a schematic block diagram of an exemplary embodiment of the AS 106. The AS 106 (see FIG. 1) is composed of two major logic sections: the IOS logic section 722, and the application logic section 721 (made up of 710, 712, 714, 715, 716, 718, and 720 in FIG. 7). The IOS logic section 722 comprises the same logic found on an IOS 104, except that the I/O ports 656 (see FIG. 6) that were normally exposed externally are now connected to the I/O ports on the FC and/or Gigabit Ethernet controllers 718 in the application logic section 721. The application processing logic section of the AS 106 may comprise one or more high performance general purpose Application Processors (“AP”) 710 attached to a combination application memory controller and I/O bus bridge 712 (commonly called the “North Bridge” in the industry). A main memory (SDRAM) 720 may be coupled to the North Bridge 712 for use by the APs 710 and any device on an I/O bus capable of direct memory access through the North Bridge 712. There may be downstream I/O bus bridges 716 that are used to connect the I/O busses 714a (e.g., PCI, PCI-X, etc.) to the North Bridge 712 via a HSB 715. Alternatively, the North Bridge 712 may interface directly with the I/O busses 714b (e.g., PCI, PCI-X, etc.). On the I/O busses 714, there may be any number of FC controllers and/or Gigabit Ethernet controllers 718 that are connected to the external I/O ports 740 of the NPs 512 in the IOS logic section. In a preferred exemplary embodiments of the invention, it is contemplated and within the scope of the present invention that all of the I/O controllers 718 may be FC controllers, all of the I/O controllers 718 may be Gigabit Ethernet controllers, or any combination thereof, or other protocol controller providing sufficient bandwidth.

In addition, there may be several different methods of physically and mechanically packaging the application logic section 721 and the IOS logic section 722 in the embodiments of the invention. One method may place both the application logic section 721 and the IOS logic section 722 on the same printed circuit board/assembly as one physically integrated unit. In this case, the I/O ports of each section may be connected together via printed circuit board traces. Another exemplary embodiment of this invention might package the application logic section 721 on a single printed circuit board/assembly and use an existing IOS 104, on a separate printed circuit board/assembly, for the IOS logic section. In this case, the I/O ports on the two sections may be connected together via physical copper or optical cabling.

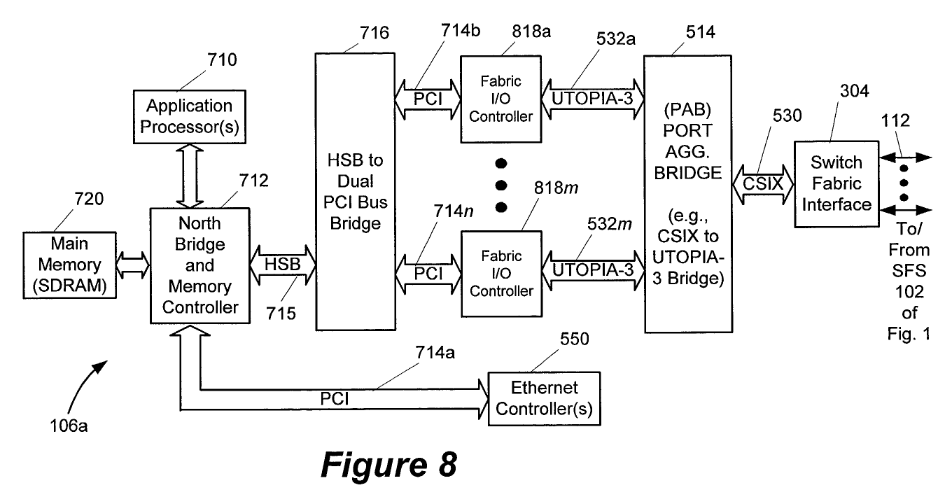

FIG. 8 depicts a schematic block diagram of another exemplary embodiment of the AS. The AS, generally represented by the numeral 106a, comprises some of the same logic found in the previous exemplary embodiment of an AS 106, but the NPs 512, FC controllers 718, and Gigabit Ethernet controllers 718 may be replaced by special Fabric I/O Controllers (“FIOC”) 818 that are custom designed to provide a high performance interface directly from the AP's I/O busses 714 (e.g., PCI) to the PAB 514 (and hence to the SFS 102 via the SFI 304). Also note that because the NPs were removed, there is no need for the IOS processor 518 since that device primarily provided the management and control of the NPs. The IPC Ethernet controllers 550 may be connected to the application logic section 721 for IPC with the other subsystems that comprise the Storage Network Switch 100. According to the exemplary embodiment, there are dual Ethernet controllers 550 that can be used as part of a redundancy or fault-tolerance enhancement to the present invention by, for example connecting to the redundant Ethernet IPC networks, via the serial communications links so that each of the Ethernet controllers 550 connect to one of the networks and the controllers are attached to the application logic section 721 via the PCI bus 714.

The remainder of the application logic section 721 is similar to logic illustrated in FIG. 7. The exemplary embodiment depicted in FIG. 8 illustrates a more optimized implementation of the AS 106a that may improve performance, reduce component count, and provide better density than the exemplary embodiment depicted in FIG. 7. Further improvement can be accomplished by integrating the FIOC 818 with the PAB 514 into a single high performance controller (not shown).

### Network Processors

The exemplary embodiment of the invention depicted in FIG. 7 may use APs 710 in combination with the controller 718 (which may be PCI, dual port FC, or Gigabit Ethernet) as a connection between the switch fabric subsystem 102 and the PCI bus or bus(ses) 714 coupled to the AP 710 (through the North Bridge 712). In FIG. 7, a dual port NP may be directly attached to a dual port FC controller. The AP 710 executes software that sends and receives FC frames to and from the SFS 102 by sending and receiving the frames to the attached PCI FC controller 718 (again, the FC controller 718 may be PCI, dual port fiber channel, Gigabit Ethernet, or a protocol of equivalent capability). The FC controller 718 forwards these transmit and receive frames to the attached NP 512 in the IOS logic section 722. The NPs on the AS 106 perform the same functions as they do on the IOS 104. They send and receive FC frames from their I/O ports and forward them to and from the PAB 514 and the SFI 304.

A preferred exemplary embodiment of the AS 106a does not require NPs because the FC controller and NP combination may be replaced by a custom FIOC 818 that directly attaches the data bus 532 to the PAB 514 which is coupled to the switch fabric 112 through the SFI 304 and data bus 530, as illustrated in FIG. 8. This exemplary embodiment of the present invention drastically reduces the complexity of the AS 106a and allows it to run at full fabric interface bandwidth because the FIOC 818 is designed to provide I/O port bandwidths that match the bandwidth provided by the high speed fabric interface busses.

### Port Aggregation Bridge (“PAB”)

The PAB 514 of FIG. 8 serves the same function as it does on the IOS 104 of FIG. 1.

### Switch Fabric Interface Device (“SFI”)

The SFI 304 of FIG. 8 provides the same function as it does on the IOS 104 of FIG. 1.

### Fibre Channel Controller (“FC”)

The FC Controller 718 may be an off-the-shelf device that is used to provide FC I/O services on an I/O bus (e.g., PCI). Typically, these devices may implement the FC-0 (physical), FC-1 (transmission protocol), FC-2 (signaling protocols), FC-3 (services), and FC-4 (upper layer protocols) protocols required to implement an end node in a FC network (as defined by the ANSI T 11 series of standards). The basic functionality of most FC controllers 718 is to provide a SCSI over FC function that allows SCSI formatted block storage access to be performed over a FC network. The FC controller 718 may typically operate in an initiator, target, or in both modes of operation. An initiator is a node that initiates a storage access command like READ, WRITE, or REWIND and expects the operation to be carried out by a target on the storage network. A target usually contains some form of storage (disk, tape, RAM disk, etc.) and accepts storage access commands and performs the operation on its local storage media. A target may respond to the initiator with the status of the storage access command.

In the exemplary embodiment of the AS 106 depicted in FIG. 7, the FC controllers 718 are used to operate in both initiator and target modes of operation. The controllers are set up to operate in target mode to accept storage access command frames forwarded to the AS 106 from the various IOS in the storage network switch. The FC controllers 718 provide the low level processing of the frames and forward the commands to the AS 106 main memory where the application or general purpose processor(s) may act on the storage request (i.e., will the FC controller 718 process the commands itself, or will the FC controller 718 forward the commands to another FC node in the network for processing?). In the case where the commands must be forwarded to other FC nodes in the storage network, the FC controllers 718 may operate in an FC initiator mode of operation. The commands may be sent to the FC controllers 718 where the commands are packaged into the proper low level frame formats and sent to the network via the NPs and SFS 102. The remote FC nodes may be other ASs 106 installed in the storage network switch 100, or they may be other external FC devices attached directly to an external port on an IOS 104 installed in the storage network switch 100.

### Gigabit Ethernet Controller

The Gigabit Ethernet Controller 718 may be an off-the-shelf device that is used to provide Ethernet I/O services on an I/O bus (e.g., PCI). Typically, these devices provide the physical and Media Access Control (“MAC”) protocols as defined by the IEEE 802 series of standards. The basic functionality of a Gigabit Ethernet controller 718 is quite simple: it merely provides a set of transmit and receive frame services for sending and receiving Ethernet frames to and from an Ethernet network. These frames are generated and received via the I/O bus, e.g., PCI bus and the like.

### Fabric I/O Controller (“FIOC”)

The FIOC 818, illustrated in FIG. 8, is a device that is designed to replace the combination of the FC or Gigabit Ethernet controllers 718 and a NP 512. The FIOC 818 provides the same services via the I/O bus (e.g., PCI bus) to the application or general purpose processors, but instead of a native FC or Gigabit Ethernet physical and transmission level interface, the device uses a fabric interface bus like UTOPIA-3, CSIX or SPI-4. The FIOC 818 provides many of the same services that the NP 512 provided as far as the interface functions to the fabric interface. In other words, the cell headers are set up and parsed properly, flow control signals and message cells are generated and received properly, and frame-to-cell segmentation and re-assembly are handled properly.

The FIOC 818 may also have access to the routing tables used in routing frames and cells properly though the switch fabric. Normally, on an IOS, the IOS processor 518 accepts route table updates from the SCS 108 and loads these updates into the NP's table look-up memory. In the FIOC 818, the application processor accepts the route table updates from the SCS 108 and loads them into the proper locations in the FIOC 818 so that it knows how to forward frames/cells to destination nodes on the FC or Ethernet networks.

### Application Memory Controller and I/O Bus Bridge

The ANB 712 is commonly called a North Bridge and is a combination application memory controller and I/O bus bridge. The ANB 712 device preferably provides: 1) memory interface, memory control, and memory access functions for memory requests from the application processor as well as from the devices on the I/O buses (e.g., Gigabit Ethernet, FC, and FIOC; 2) a processor interface to connect to one or more application or general purpose processors; and 3) one or more I/O bus interfaces to allow the processors to access the I/O devices as well as to allow I/O devices access to the memory attached to the memory interface. The memory attached to the memory interface of the ANB 712 may be the main memory 720 of the application processors 710. When the application processors 710 are initialized, they can initialize the ANB's 712 configuration and initialize the main memory 720. In addition, the APs 710 can access the I/O devices on the I/O busses through the ANB 712. When the system is initializing, software executing on the APs 710 may initialize the I/O devices to be in such a state as to allow the I/O devices to perform I/O operations at the request of the AP(s) 710. The ANB 712 provides high bandwidth access to memory for the I/O devices attached to the I/O bus(ses). Typically, in high performance AP architectures, the ANB 712 provides access to the I/O bus(ses) via one or more HSBs 715. The conversion of the HSB 715 signals to the I/O bus 714 signals is performed by the HSB/PCI Bridge 716. The software executing on the APs 710 manages the use of the memory to allow ordered data accesses and communication of data through memory based data structures utilized by both the AP(s) 710 and the I/O devices.

The ANB 712 device characteristics preferably are high memory capacity (4 GB or greater) and high memory bandwidth (greater than 4 GB/s), and high I/O bandwidth across the I/O busses (greater than 4 GB/s aggregate). An advantage of this ANB 712 architecture is the memory capacity and the bandwidth available for moving data into and out of memory from both the application processor(s) and the I/O devices on the I/O busses.

### HSB/PCI Bridge

The HSB/PCI Bridge 716 is a device that provides connectivity between one of the HSBs 715 from the ANB 712 and one or more I/O busses, most typically PCI bus 714, although other types of busses may be used. In a preferred exemplary embodiment shown in FIG. 7, the HSB/PCI Bridge 716 has one connection to an HSB 715 from which it receives I/O access requests and memory responses from the ANB 712. The HSB/PCI Bridge 716 also has two connections to two separate and independent PCI I/O busses 714 from which the HSB/PCI bridge 716 can receive memory requests and access responses. The HSB/PCI Bridge 716 forwards I/O requests to the appropriate PCI device and returns the responses from the PCI busses 714 to the HSB 715 and the ANB 712. Likewise, when I/O devices 718 attached to the PCI busses 714 make memory read and write requests, the HSB/PCI Bridge 716 forwards these requests to the HSB 715 (and hence, the ANB 712) and then forwards the responses back to the PCI bus 714 from which the memory request was made.

### Application or General Purpose Processor(s) (“AP”)

The Application or General Purpose Processor(s) 710 execute software that provides the high level services needed in the storage network switch. These processors are preferably off-the-shelf high-performance CISC or RISC processors such as those used in servers and workstations. Preferably the AS 106 partitions the frame level processing from the high level service software in the system. Frames received on the external ports of the IOS 104 are parsed, and a determination is decided at the low level protocol layers whether or not to forward the frame to an appropriate AS 106. A good deal of the information that is parsed in the frame can be inserted into the frames so that once they are forwarded to the AS 106, the application processors can skip the low level processing and immediately process the high level protocols, thus drastically improving performance relative to application appliances or servers that are external to a switch. An advantage of the present invention is that the application appliance may be directly integrated into the storage network switch which results in tight functional coupling with the NPs in the IOS 104.

The AP(s) 710, ANB 712, HSBs 715, HSB/PCI Bridge 716, I/O busses 714, and I/O controllers (FC and Gigabit Ethernet) 718 may be used to develop the AS 106 in a manner that allows high performance through tight integration of the low level protocol processing done in the IOS 104 with the high level processing done by the AS 106 specific components. The AS 106 specific components may provide the same functionality as an external appliance, workstation, or server. The AP(s) 710 may execute on a variety of operating systems including Linux, embedded Windows, manufactured by the Microsoft Corporation of Redmond, Wash., and off-the-shelf real-time operating systems like Wind River's VxWorks and the like. System Control Subsystem (“SCS”)

The SCS 108 (see FIG. 1) provides the overall system management for the storage network switch 100. System management comprises: 1) providing the physical and logical interface for the user to manage and control the storage network switch; and 2) providing the central focal point for control information in the switch for the proper operation of all protocols and functionality provided by the storage network switch. Providing the management interface to the storage network switch means that, via either the local Ethernet and/or the serial ports, a user can manage the switch using management application tools (e.g., network management applications like HP Openview, manufactured by the Hewlett-Packard Corporation of Palo Alto, Calif.; BMC Patrol, manufactured by BMC Software of Houston, Tex., etc.) or standard communications tools like TELNET terminals, SSH terminals, serial attached console terminals (VT 100) or terminal emulation programs (e.g., Microsoft Windows Hyperterminal). The SCS 108 implements the standard SNMP with management information bases (“MIBs”) and protocols to allow it to be managed remotely from custom or industry standard management applications. Likewise, the SCS 108 implements a command line interface (“CLI”) that can be accessed directly via a physical serial port or remotely via TELNET over TCP/IP over the Ethernet.

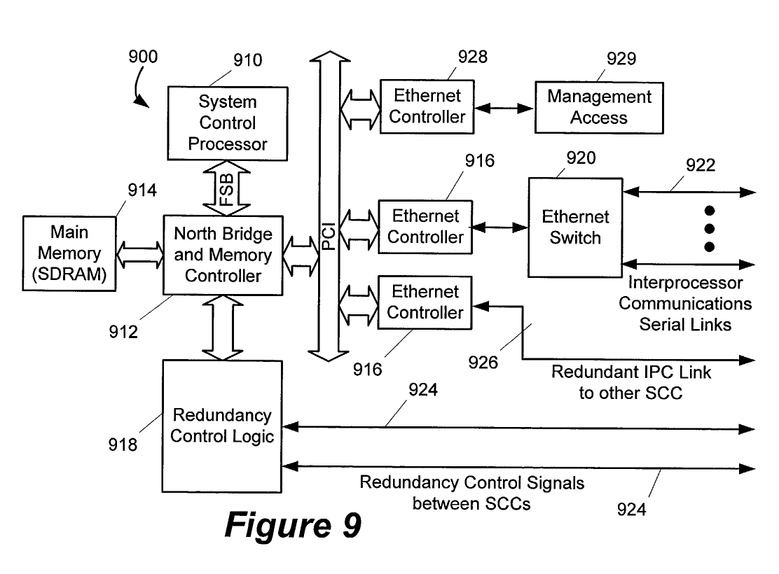

The SCS 108 may be implemented using a pair of System Control Cards (“SCC”) 900 that operate in an active/standby pair. FIG. 9 illustrates the overall architecture of the major components on each SCC 900. On power up, the two SCCs initialize themselves and then negotiate for the active status. This negotiation process takes place via the use of the Redundancy Control Logic (“RCL”) 918 which manipulates a set of redundancy control signals 924 that are connected between the two SCCs 900. The RCL 918 and the redundancy control signals 924 implement an arbiter function that allows only one of the SCCs to be active at one time. Once the controllers decide which SCC 900 may be active, the other SCC 900 may assume the standby role. The active SCC 900 may have all tasks, processes, and interfaces active for operating the switch and interfacing to the users/administrators of the switch. The standby SCC 900 may place most of its tasks, processes and interface in a quiescent state. Preferably, the only software function actively executed on the standby SCC controller 900 is a redundancy component that copies changes to the configuration of the switch, error logs and other control data structures from the active SCC 900 needed in case the standby SCC 900 must become the active card.

A feature of the present invention is that in the event of a software or hardware failure on the active SCC 900, the software/hardware may initiate a fail-over event in the fault tolerant logic of the standby SCC 900, such that the active SCC 900 immediately releases active control and the standby SCC 900 immediately assumes the active status. In this event, the software in the newly controlling SCC 900 may activate all its tasks, processes and interfaces in order to begin processing management requests and to continue the operational control of the switch system.

### System Control Processor (“SCP”)

The System Control Processor (“SCP”) 910 may be an off-the-shelf general purpose microprocessor that provides enough CPU computing power and data throughput to perform the system management and operation control of the storage network switch 100 of the present invention.

### Embedded Memory Controller and I/O Bus Bridge (“North Bridge”)

Referring to FIG. 9, the Embedded Memory Controller and I/O Bus Bridge 912 device is commonly called the North Bridge 912. This device provides: 1) memory interface, memory control, and memory access functions for memory requests from the SCP 910 as well as from the devices on the I/O buses (e.g., Ethernet, IDE/ATA disk drive controller, etc.); 2) a processor interface to connect the SCP 910 to the rest of the subsystem; and 3) an I/O bus interface (e.g., a PCI bus) to allow the SCP 910 to access the I/O devices, as well as to allow the I/O devices access to the memory attached to the memory interface. The SDRAM memory 914 that is attached to the memory interface of the North Bridge 912 is the main memory of the SCP 910. When the SCP 910 is initialized, it will initialize the North Bridge 912 configuration and initialize the memory. In addition, the SCP 910 may access the I/O devices on the I/O busses through the North Bridge 912. When the system is initializing, software executing on the SCP 910 may initialize the I/O devices to be in a state to allow the I/O devices to perform I/O operations at the request of the SCP 910. The North Bridge 912 provides high bandwidth access to memory for the I/O devices attached to the I/O bus(ses). The software executing on the SCP 910 may manage the use of the memory to allow ordered data accesses and communication of data through memory based data structures utilized by both the SCP 910 and the I/O devices. Ethernet Controllers

The SCC 900 may use 100 Mb/s Ethernet controllers 916 for two different functions in the storage network switch: 1) a number of Ethernet controllers 916 may be used for attaching directly to external ports on the SCC 900 in order to provide network-based management access 929 to the storage network switch 100; and 2) a number of Ethernet controllers 916 may be used to communicate with the other SCCs 900, the various IOS 104 in the switch, and the AS 106 in the switch.

### Management Ethernet Controllers

The Management Ethernet Controllers 928 may be used by all users to manage the SNS via standard management protocols such as TCP/IP, SNMP, TELNET, and TFTP. Users may use network management applications or tools to access, monitor, and control the SNS through these management Ethernet ports.

### Interprocessor Communications (“IPC”) Ethernet Controllers

IPC Ethernet Controllers 916 may be used for internal interprocessor communications. The IPC network is a switched 100 Mb/s Ethernet network that is used to pass control information among the various subsystems in the SNS. All IOS, AS, and SCC have an IPC Ethernet port to communicate control and status information throughout the system. In a preferred exemplary embodiment of this invention, there are two IPC Ethernet controllers 916, one that connects directly to the IPC network implemented via the local Ethernet Switch 920, and one that is connected to the Ethernet Switch 920 in the other SCC 900 via an inter-SCC IPC link 926. Likewise, the other SCC 900 has an IPC Ethernet connection to its own Ethernet Switch 920 and another IPC Ethernet controller 916 that is connected to the local SCC's 900 Ethernet Switch 920 via an inter-SCC link 926. In this way, each SCC 900 has two redundant communications paths for interprocessor communication to the other SCC 900.

### IPC Ethernet Switch

The IPC Ethernet Switch 920 implements an internal 100 Mb/s Ethernet network that is used by the various subsystems in the SNS to communicate status and control information. There are redundant IPC networks implemented in the storage network switch because each SCC 900 implements an IPC Ethernet Switch 920 device. Every SCC 900, IOS 104, and AS 106 have IPC Ethernet connections to both IPC Ethernet networks via Ethernet links 922, 926 to each SCC's 900 IPC Ethernet Switch 920. Typically, each subsystem may normally communicate through the IPC Ethernet Switch 920 on the active SCC 900. If a subsystem can no longer communicate with other subsystems, it may attempt communications through the IPC Ethernet Switch 920 on the standby SCC 900.

### Redundancy Control Logic (“RCL”)

The RCL 918 on the SCC 900 performs the arbitration between the SCCs 900 to determine which may achieve active status. This arbitration is carried out via redundancy control signals 924 that are connected between the two SCCs 900. The logic is designed such that only one of the SCCs 900 can be active at any given time. The RCL 918 has both software inputs and hardware inputs to determine if the local SCC 900 may try to arbitrate for active status. The software inputs are registers that allow the software to indicate that it is not ready to achieve active controller status. If these registers are set to “not ready”, then the arbitration logic will always select the other SCC 900 to win the arbitration. The hardware inputs allow the hardware to indicate hardware faults which may also prevent the RCL 918 from arbitrating for active status. In addition to these functions, the RCL 918 also sends its current active/standby status via the redundancy control signals 924 so that the other SCC 900, the IOS 104 and AS 106 can see the current active standby status of both SCCs 900.

### Data and Control Information Flow

This section may describe the flow of data through the storage network switch 100 for a variety of scenarios.

### Software

Operation of an exemplary embodiment of the Storage Network Switch 100 is explained more fully herein.

### Data Flow

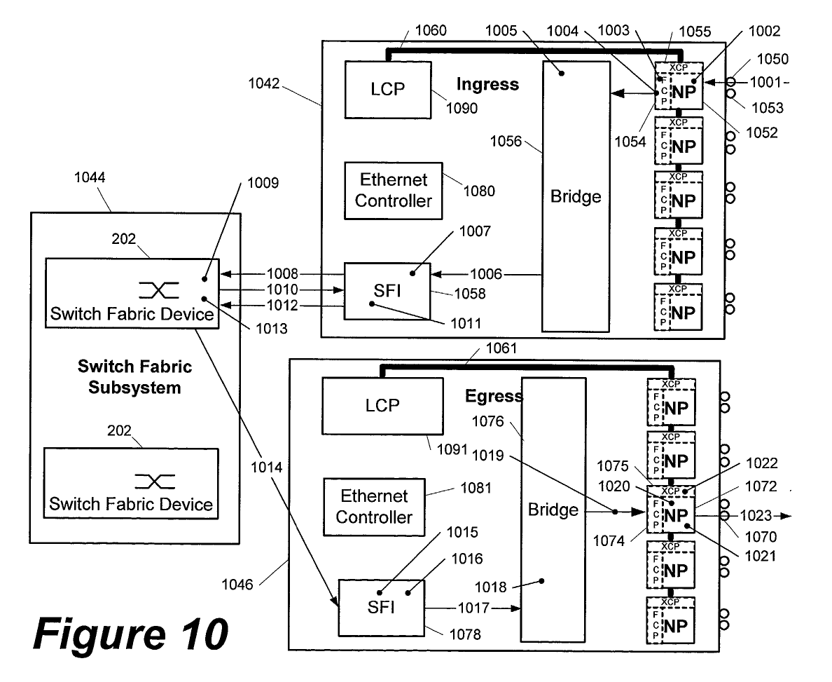

Referring now to FIG. 10, depicted is a schematic block diagram of data flow through an exemplary embodiment of the present invention. FIG. 10 has three major elements, namely, the ingress line card 1042, the SFS 1044, and the egress line card 1046. In a preferred exemplary embodiment of the present invention, the egress line card 1046 has the same capabilities as the ingress line card 1042, although this is not absolutely necessary. The egress line card 1046 can have some reduced functionality while still being able to implement many of the methods of the present invention.

In a preferred exemplary embodiment of the present invention, the ingress line card 1042 has one or more NPs 1052. Each of the NPs 1052 has an XCP 1055, and an FCP 1054. Preferably, each of the NPs 1052 also has two ports 1050 and 1053 through which data flows in or out. The ingress line card 1042 has a bridge 1056 that is coupled to the network processors 1052. The NPs 1052 are also coupled to a line card processor 1090 via data bus 1060. The data bus 1060 need not be any particular kind of data bus. For example, a PCI bus can be used in this capacity. However, any kind of data bus having sufficient bandwidth and latency is acceptable for the present invention. The line cards 1042 also preferably have one or more Ethernet controllers 1080, which are used to pass control information between itself and the SCS. Although Ethernet is preferably used with this aspect of the present invention, other network protocols could be used with equal effect with the present invention. Finally, the ingress line card 1042 is preferably equipped with a SFI 1058 which interfaces with components of the SFS 1044.

The SFS 1044 contains one or more switch fabric devices 202 which interface with one or more line cards (either ingress and/or egress line cards).

The egress line card 1046 is preferably identical to the ingress line card 1042. As with the ingress line card 1042, the egress line card 1046 has one or more NPs 1072. Each of the NPs 1072 has an XCP 1075 and a FCP 1074. The NPs 1072 are coupled to the egress line card processor 1091 via data bus 1061, as illustrated in FIG. 10. As with the ingress line card 1042 and its data bus 1060, the data bus 1061 in the egress line card 1046 need not be any particular kind of data bus. Any kind of data bus having sufficient bandwidth and latency, such as a PCI data bus, is acceptable for the present invention. Similarly, the egress line card 1046 has a SFI 1078 that is coupled to the SFS 1044, and an Ethernet controller 1081. Finally, a bridge 1076 establishes a coupling between the SFI 1078 and the NPs 1072.

According to an exemplary embodiment of the method of the present invention, in step 1001, a frame from the network arrives on an ingress port 1050 of an NP 1052. In step 1002, the NP 1052 simultaneously moves the frame into a buffer in the NP's 1052 buffer memory while the NP 1052 parses the header of the frame, wherein: the NP 1052 first decodes addresses in the frame header; performs a check, such as a CRC to detect data transmission errors; performs a table look-up (“TLU”) to determine the destination port (dest_port); creates a descriptor data structure that describes where the frame is in buffer memory and to what destination NP 1052 and egress port number the frame is to be sent; imbeds the dest_port into the frame descriptor that it created, and queues the frame descriptor for transmission to the FP 1054 within the NP 1052.

In step 1003, a FCP 1054 on the NP 1052 segments the frame into, for example, but not limited to, 80-byte cells (64-byte payload and 16-byte cell header) and adds the destination port information (“dest_port”) to every cell header it generates. The dest_port field is used by the switch fabric hardware and the destination egress NP 1072 to route the frames to the appropriate egress switch port 1070. In step 1004, the NP 1052 forwards the cells to the bridge 1056. In step 1005, the bridge 1056 performs multiplexing and buffering of cells from the multiplicity of NPs 1052 attached to it so that a steady stream of cells flows to the switch fabric devices 202c. In step 1006, a single-rate, nominally 10-Gb or greater stream of cells may be sent from the bridge 1056 to the SFI 1058. In step 1007, the SFI 1058 receives the frame and performs port selection and de-multiplexing. For each cell, the SFI 1058 reads the dest_port information from the cell header and determines which one of the serial links to send the cell through. In step 1008, an arbitration request is sent from the SFI 1058 on a line card 1042 to the switch fabric device 202 on the serial link that was selected for that cell's transmission to the SFS 1044, as illustrated in FIG. 10. The SFI 1058 sends the dest_port information to the switch fabric device 202, thus enabling the switch fabric device 202 to find an appropriate egress serial link to the egress line card 1046.

In step 1009, the switch fabric device 202 determines the correct egress path for the cell through itself. When the switch fabric device 202 has determined that the egress path is free for use, step 1010 is taken where the arbitration response is sent, via the serial link from which the arbitration request was made, back to the SFI 1058 on the ingress line card 1042. In step 1011, the SFI 1058 on the line card 1042 queues the actual cell for transmission to the switch fabric device 202. In step 1012, a cell or frame is transmitted from the SFI 1058 on the line card 1042 to the switch fabric device 202 via the same serial link in which the arbitration request was made for that cell. In step 1013, a preferably first-in first-out (“FIFO”) buffer receives the cell internal to the switch fabric device 202, and the switch fabric device 202 immediately forwards the cell to the destination egress port 1070 that was determined during the arbitration process. It will be understood by those skilled in the art that queues other than FIFO queues could also be used with equal effect by the present invention.

The switch fabric device 202 forwards the cell to the destination egress port 1070 through a series of steps beginning with step 1014, in which the cell is transmitted from the switch fabric device 202 to the SFI 1078 on the line card 1046 that corresponds to the destination egress port (dest_port) 1070. In step 1015, the SFI 1078 on the destination line card 1046 accepts the cell and checks the validity of the cell. In step 1016, the SFI 1078 performs multiplexing of the serial channels into one CSIX stream. In step 1017, the cells are transmitted from the SFI 1078 to the bridge 1076 via, for example, the CSIX bus. In step 1018 the bridge 1076 reads the destination in the cell headers and performs de-multiplexing for transmission to the proper egress NP 1072.

In step 1019, the cell is transmitted from the bridge 1076 to the egress NP 1072. In step 1020, the FP 1074 within the egress NP 1072 reassembles the cells into the original frame in the NP's 1072 internal (or external) buffer memory. If this is the first cell of a frame, the FP 1074 within the NP 1072 allocates a frame descriptor to keep track of the location of the frame in the NP 1072 buffer memory. When the start of the frame cell is received in step 1021, the FP 1074 determines to which of the NP's 1072 two I/O ports 1070 to send the frame. In step 1022, when the FP 1074 within the NP 1072 receives the end of the frame cell, the FP 1074 queues the frame for transmission to the appropriate destination egress I/O port 1070. Then in step 1023, the NP 1072 transmits the frame out of the egress port 1070.

### Control Flow

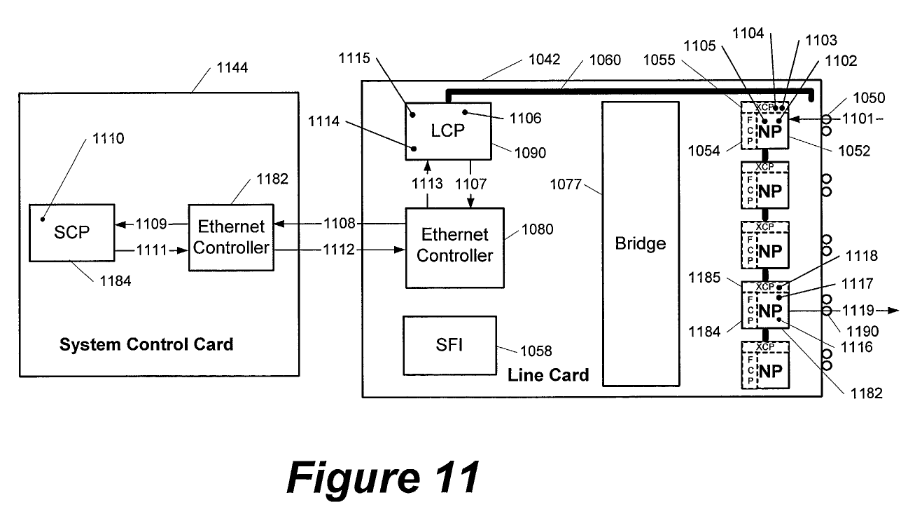

Referring now to FIGS. 11, 12 and 13, depicted are schematic block diagrams of control flow through an exemplary embodiment of the present invention. In FIG. 11, step 1101, a frame from the network arrives on the ingress port 1050 of a NP 1052. In step 1102, the ingress NP 1052 moves the frame into a buffer in the NP's buffer memory while it parses the header of the frame, wherein the NP 1052: decodes addresses in the frame header; performs a check, such as a CRC, to detect data transmission errors; performs a TLU to determine the destination port (dest_port) (Note—In the case of a control frame, the TLU determines that the frame is not to be forwarded to another NP port, but is to be processed by the LCP 1090); creates a descriptor data structure that describes where the frame is in the buffer memory and that the frame is to be queued to the LCP 1090, and queues the frame descriptor to the XCP 1055 of the NP 1052 for transmission to the LCP 1090.

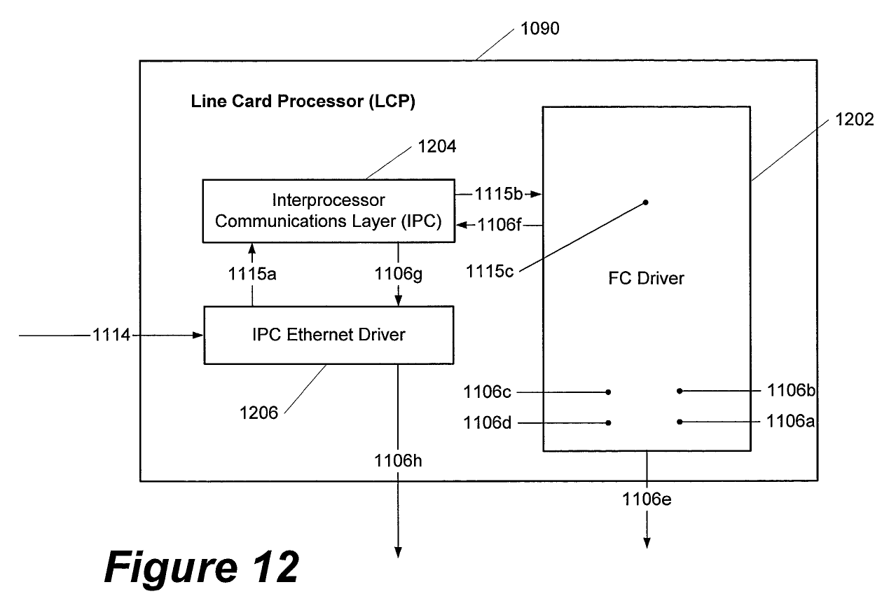

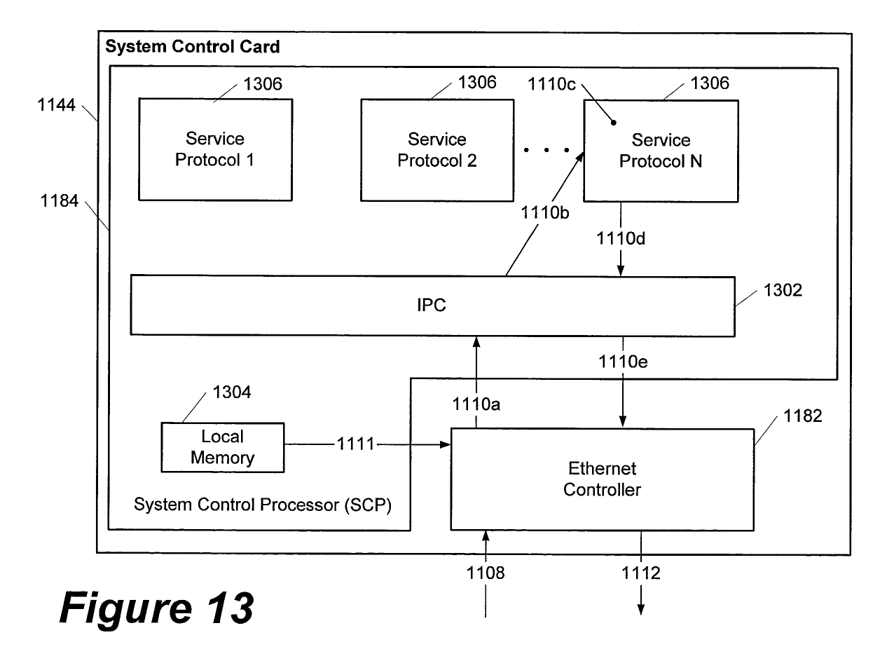

In step 1103, the frame is processed by the XCP 1055 of the NP 1052, wherein the XCP 1055 controls the PCI interface 1060 and the XCP 1055 performs additional frame validation, such as: if the frame is not valid or is merely dropped, a negative acknowledgement response frame is formatted and queued for transmission to the port 1050 from which the original frame was received; and, if the frame is valid, it is queued for transmission to the LCP 1090. In step 1104, the XCP 1055 moves the frame data to the LCP 1090 over the data bus 1060 and into the LCP's local memory. In step 1105, the NP 1052 interrupts the LCP 1090 to inform it that the frame is in the LCP's 1090 local memory. In step 1106, the FC driver software of the LCP 1090 performs more detailed parsing on the frame. The remaining steps of FIG. 11 are described in general and specific detail in the following description with reference to FIGS. 12 and 13, as well as to FIG. 11.

Referring now to FIG. 12, step 1106 of FIG. 11 is explained in greater detail. Specifically, in step 1106a, the FC driver 1202 extracts the transmission protocol to identify the frame type, e.g., Switch Fabric Internal Link Services (“SWILS”), FC Common Transport (“FCCT”), Basic Link Service (“LS”), Extended Link Service (“ELS”) and the like. In step 1106b, the FC driver 1202 on the LCP 1090 identifies the target protocol service on the switch that handles the identified frame type. In step 1106c, if the frame is not a request, or, if it is a request but no acknowledgement is required, then execution of the method jumps directly to step 1106f.

In step 1106d, the FC driver 1202 on the LCP 1090 formats the acknowledgement frame in local memory. In step 1106e, the FC driver 1202 on the LCP 1090 interrupts the NP 1052 (see FIG. 11) to inform it that there is a frame to be sent out on one of the egress ports. The NP 1052 processes the acknowledge frame in the same way as it processes the response frame, as will be illustrated in steps 1115 through 1118 of FIG. 11 described below. In step 1106f, the FC driver 1202 on the LCP 1090 forwards the frame to the IPC 1204. In step 1106g, the IPC 1204 on the LCP 1090 forwards the frame to the IPC Ethernet driver 1206. In step 1106h, the IPC Ethernet driver 1206 queues the frame to the IPC Ethernet controller 1080 (see FIG. 11) for transmission to the SCP 1184 on SCC 1144.

Referring back to FIG. 11, in step 1107, a frame is transmitted from the LCP 1090 to the Ethernet controller 1080. In step 1108, a frame is transmitted from the Ethernet controller 1080 on the line card 1042 to the Ethernet controller 1182 on the SCC 1144. In step 1109, the Ethernet controller 1182 on the SCC 1144 forwards the frame to the local memory on the SCP 1184 and then interrupts the SCP 1184 to indicate a frame is ready to be processed. In step 1110, the SCP 1184 receives and processes the frame according to the control flow depicted in FIG. 13.

Referring now to FIG. 13, in step 1110a, the IPC 1302 receives the request or response frame from the Ethernet controller 1182 on the SCC 1144. In step 1110b, the IPC 1302 queues the frame to the appropriate protocol service task 1306. In step 1110c, the protocol service task 1306 processes the request or response frame, wherein in step 1110d, if the frame is a request, then a response frame is sent to the IPC 1302 for routing back to the appropriate line card. In step 1110e, the IPC 1302 formats the response frame for transmission to the LCP 1090 via the Ethernet controllers 1182 and 1080, and queues the frame to the Ethernet driver and the driver interrupts the Ethernet controller 1182 to let it know that a frame is ready for transmission.

Referring back to FIG. 11, in step 1111, the response frame is moved from the local memory 1304 on the SCP 1184 (see FIG. 13) to the Ethernet controller 1182 on the SCC 1144. In step 1112, the response frame is transmitted from the Ethernet controller 1182 on the SCC 1144 to the Ethernet controller 1080 on the line card 1042. In step 1113, the response frame is moved by the Ethernet controller 1080 on the line card 1042 to the memory associated with the LCP 1090. In step 1114, the Ethernet driver software 1206 in the LCP 1090 processes the response frame and passes it to the IPC 1204. In step 1115, the IPC 1204 of the LCP 1090 receives the response frame from the IPC Ethernet driver 1206, thereafter, in step 1115b, the IPC 1204 queues the response frame to the FC driver 1202 wherein the FC driver 1202 formats the response frame for transmission to the NP 1052 of the SCC 1144 in step 1106e.

In step 1116, the LCP 1090 interrupts the NP 1052 to send the frame. In step 1117, the NP 1052 sets up the direct memory access (“DMA”) queue (or alternative queue) to initiate a PCI transfer of the frame into memory on the NP 1052. In step 1118, the XCP 1185 receives the frame, wherein the XCP 1185: performs the final formatting of the frame; determines which physical port to use for transmitting the frame; and queues the frame for transmission out of the physical port 1190. In step 1119, the frame is transmitted out of the NP physical port 1190 to its destination.

### High-Level Application Flow

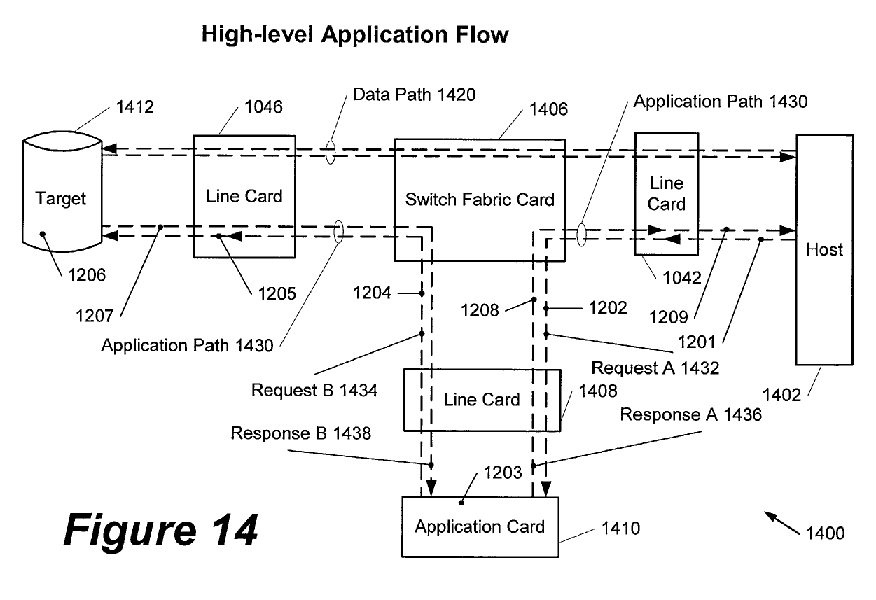

Referring now to FIG. 14, a schematic of a high-level application flow diagram is depicted according to an exemplary embodiment of the present invention. A “Request” is a storage command (read, write, or control) frame that is received on one of the ports of the line card 1042 from the host 1402 in step 1201. In step 1202, a NP 1052 of the line card 1042 processes the Request A 1432 and forwards it to the application card 1410 for further processing. In step 1203, the application card 1410 receives a Request B 1434 and determines if it can complete this Request B 1434 locally. If so, it may process the request locally and may proceed to step 1207. Otherwise, it may proceed to step 1204. In step 1204, the application card 1410 determines that it has to issue a series of one or more storage commands to one or more of the actual storage targets 1412 in order to complete the request. The application card 1410 formats one or more requests, Request B 1434, and forwards them to the line card 1046, NP 1072, and port 1070 to which the target 1412 is coupled.

In step 1205 the NP 1072 on the line card 1046 forwards the request(s) to the target(s) 1412. In step 1206, the target 1412 processes the request(s), formats one or more response frames, Response B 1438, and sends them back to the switch port and line card from which the Request B 1434 was originally sent. In step 1207, the NP 1072 on the line card 1046 receives the Response B 1438 and forwards it/them to the application card 1410. If the application card 1410 needs to send more requests to the target(s) 1412 in order to complete the original Request A 1432, then steps 1204 through 1207 are repeated until enough information has been received to complete the original Request A 1432.

In step 1208, the application card 1410 formats one or more response frames, Response A 1436, to respond to the original request sent by the host 1402 and forwards it/them to the line card 1042, NP 1052, and port 1050 that the original request was received on. In step 1209, the NP 1052 on the line card 1042 forwards the response frame(s), Response A 1436, to the host 1402 that originally sent the Request A 1432.

### Application Flow

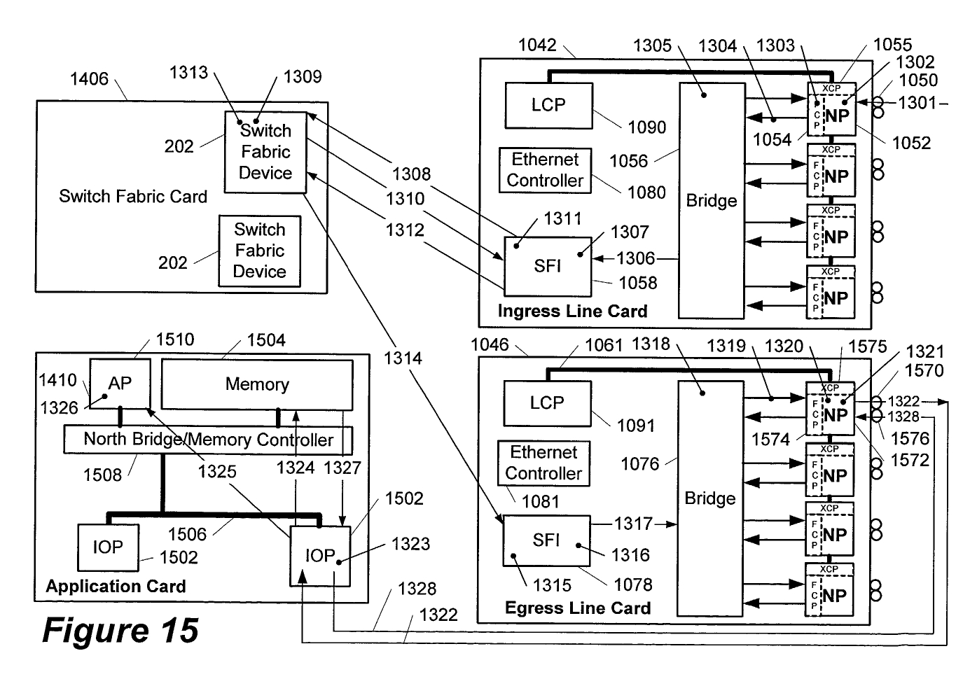

Referring now to FIG. 15, depicted is a schematic block diagram of application flow through an exemplary embodiment of the present invention. In step 1301, a frame from the network arrives on an ingress port 1050 on one of the NPs 1052 on an ingress line card 1042. In step 1302, the ingress NP 1052 parses the header of the received frame, and proceeds to: decode the addresses in the frame header; perform CRC to detect data transmission errors; perform TLU in order to determine the destination port (dest_port); perform TLU against application specific fields in the header, e.g.: i) the logical unit number, ii) the command type and iii) the destination identifier (“ID”); determine if application specific data is found in the header for which the NP 1052 would forward the frame to the application card 1410 for further processing; create a descriptor data structure that describes where the frame is located in the buffer memory as well as the destination NP 1572 and egress port number 1570 where the application card is connected; and queue the frame descriptor for transmission to the FCP 1054 within the NP 1052.

In step 1303, the FCP 1054 of the NP 1052 on the ingress line card 1042 segments the frame into, for example but not limited to, 80-byte (64-byte payload and 16-byte cell header) cells and adds the destination port information (dest_port) to every cell header it generates. The dest_port field may be used by the SFS 102 hardware and the egress NP 1572 to route the frames to the appropriate destination egress port 1570. In step 1304, the NP 1052 on the ingress line card 1042 forwards the cells to the bridge 1056. In step 1305, the bridge 1056 performs multiplexing and buffering of the cells so that a steady stream of cells flows to the SFI 1058.

In step 1306, a single-rate, 10-Gb stream of cells may be sent from the bridge 1056 to the SFI 1058 on the ingress line card 1042. In step 1307, the SFI 1058 receives the frame and performs port selection and de-multiplexing. For each cell, the SFI 1058 reads the dest_port information from the cell header and determines through which set of serial links to send the cell. In step 1308, an arbitration request is sent from the SFI 1058 on the ingress line card 1042 to the switch fabric device 202 on the Switch Fabric Card 1406. The SFI 1058 sends the destination port information to the switch fabric device 202 to find a path to the egress line card 1046. In step 1309, the switch fabric device 202 determines the correct egress path for the cell through the switch fabric. In step 1310, after the switch fabric device 202 determines that the egress link serial link to the egress line card 1046 is free, the switch fabric device 202 sends an arbitration response back to the SFI 1058 on the ingress line card 1042. In step 1311, the SFI 1058 on the ingress line card 1042 receives the arbitration response (sent from the switch fabric device 202) and queues the actual cell for transmission to the switch fabric device 202 on the Switch Fabric Card 1406. In step 1312, the cell is transmitted from the SFI 1058 on the ingress line card 1042 to the switch fabric device 202 on the Switch Fabric Card 1406, as illustrated in FIG. 15.

In step 1313 a FIFO buffer receives the cell internal to the switch fabric device 202 on the Switch Fabric Card 1406, and the switch fabric device 202 immediately forwards the cell to the egress serial link that it had reserved for the cell during the arbitration process. In step 1314, the cell is transmitted from the switch fabric device 202 to the SFI 1078 on the egress line card 1046 with the destination egress port (dest_port). In step 1315, the SFI 1078 on the destination egress line card 1046 accepts the cell and checks the validity of the cell. In step 1316, the SFI 1078 performs multiplexing of, for example but not limited to, 24 serial channels into one CSIX stream. In step 1317, a frame may be transmitted from the SFI 1078 to the bridge 1076 on the egress line card 1046.

In step 1318, the bridge 1076 of the egress line card 1046 reads the destination information in the cell header and performs de-multiplexing for transmission to the proper egress NP 1572. In step 1319, the cell is transmitted from the bridge 1076 to the egress NP 1572. In step 1320, the FP 1574 within with the egress NP 1572 reassembles the cells into the original frame in buffer memory that is attached to the NP 1572. If this is the first cell of a frame, the FP 1574 within the NP 1572 allocates a frame descriptor to keep track of the location of the frame in buffer memory that is attached to the NP 1572.

In step 1321, when the start of frame cell is received, the NP 1572 determines to which of its two ports to send the frame by reading the destination information in the cell header. In step 1322, when the FP 1574 within the NP 1572 receives the end of frame cell, it queues and transmits the frame out of the egress port 1570 of the egress line card 1046 to the Input/Output Processor (“IOP”) 1502 on the application card 1410. In step 1323, the IOP 1502 on the application card 1410 receives a frame, wherein the IOP 1502: validates the frame; and queues the frame for transmission to the AP's memory 1504 via the data bus 1506. The data bus 1506 of the application card 1410 can be any type of data bus having suitable speed and bandwidth, but is preferably a PCI bus or the like. In step 1324, the frame is transmitted to the AP's memory 1504 via the PCI bus 1506 and the North Bridge 1508. In step 1325, the IOP 1502 on the application card 1410 sends a frame reception interrupt to the AP 1510.

In step 1326, the AP 1510 processes the frame using the following logic flow:

a) if the frame is a storage request frame and it can be processed locally then AP 1510 processes the frame by:

1) generating a response frame(s) in the memory 1504,

2) queuing the response frame(s) for transmission to the IOP 1502 on the application card 1410, and

3) freeing the memory of the storage request frame received from the IOP 1502 in step 1323; and

b) if the frame is a storage request frame and cannot be processed locally then the AP 1510 processes the frame by:

1) determining the proper set of storage requests that are necessary to be sent to the remote target storage devices in order to carry out the storage request received from the IOP 1502;

2) generating the set of storage request frames for transmission to the target device(s);

3) queuing the storage request frames for transmission to an IOP (not necessarily the same IOP the original storage request frame was received from);

4) queuing the original request frame(s) received in step 1323 on a “pending” queue in memory;

5) waiting for the response frames from the target device(s);

6) dequeuing the original storage request frame and generating a response frame(s) for the original request in application card's 1410 memory 1504 once all the response frame(s) from the target device(s) are received;

7) queuing the response frame(s) for transmission to the IOP from which the original storage request frame was received; and

8) freeing the memory of the original received request and frames associated with the requests and responses to/from the target device(s).

In step 1327, the IOP 1502 moves the response frame(s) from the memory 1504 of the application card 1410 across the data bus 1506 via the North Bridge/Memory Controller 1508. In step 1328, the NP 1572 on the egress line card 1046 receives one or more response frames from the IOP 1502 of the application card 1410. The NP 1572 then processes the frame just as it would in the normal data flow discussed above, with the ultimate purpose of sending the response frame(s) back to the port on the storage network switch from which the original storage request frame was received.

### Operation and Method

The operation of the present invention can best be illustrated first by several simplified block diagrams, and then with the aid of several flow charts. The method of the present invention encompasses three critical paths: the data path; the control path; and the application path. An optional network management system path may be added in order to facilitate configuration, monitoring, and control of the present invention. Finally, the distributed nature of the processing that occurs during the performance of the method of the present invention will also be discussed in order to illustrate the unique characteristics and scalability of the present invention.

### OVERVIEW OF EXAMPLE 1

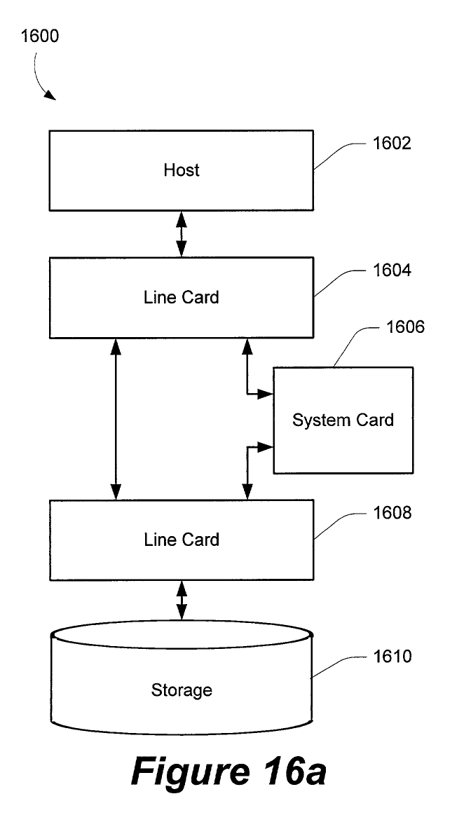

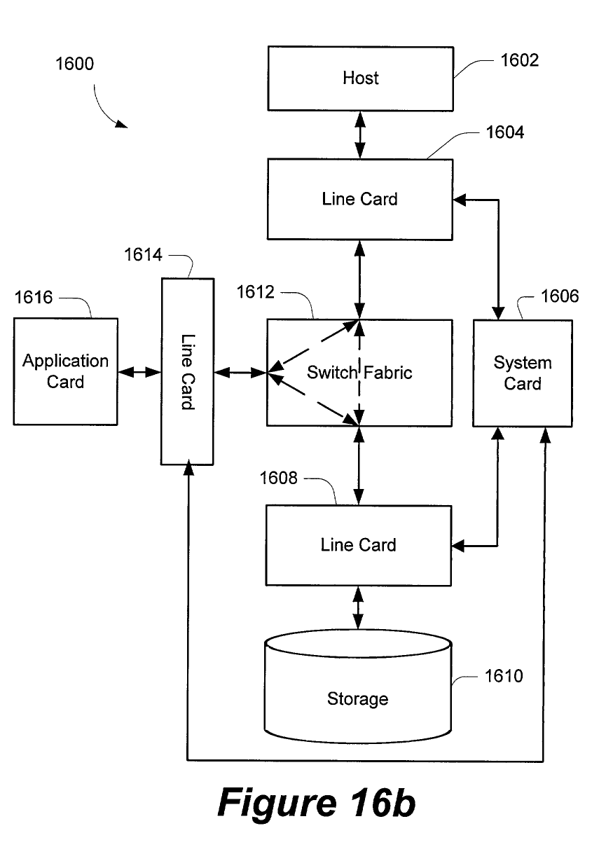

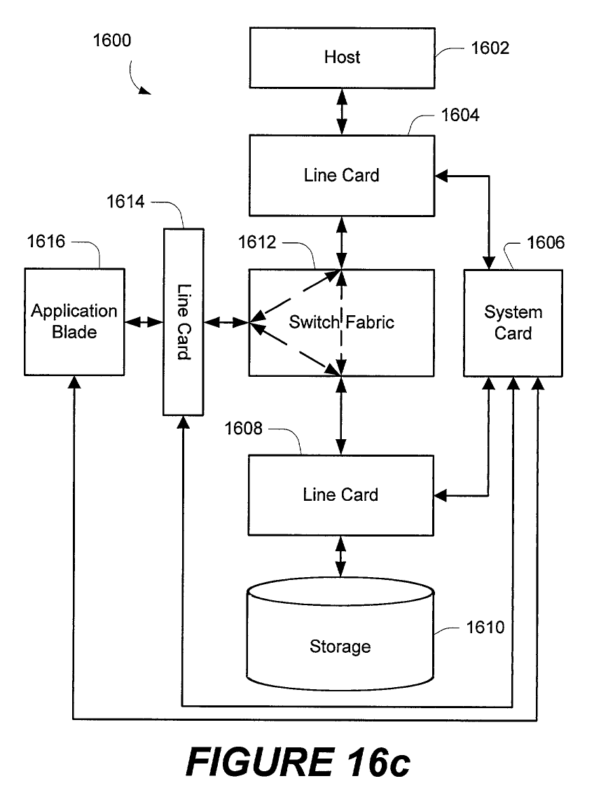

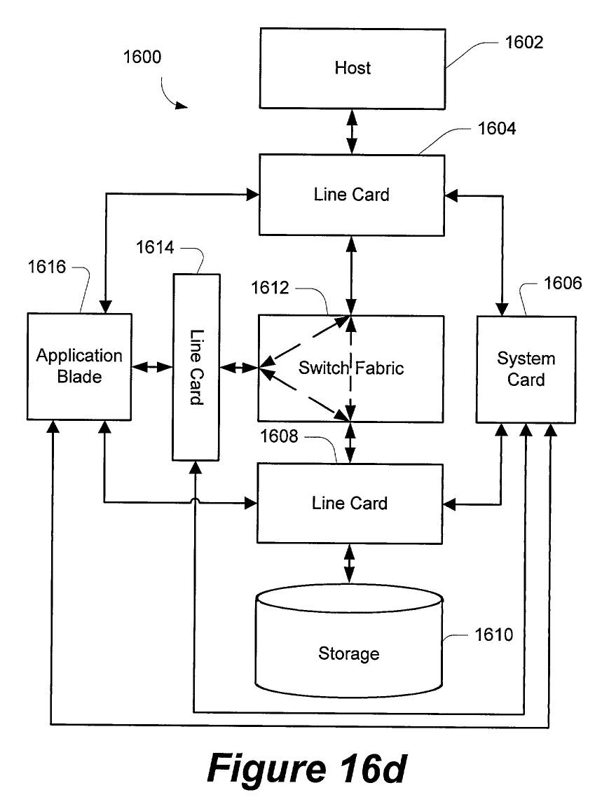

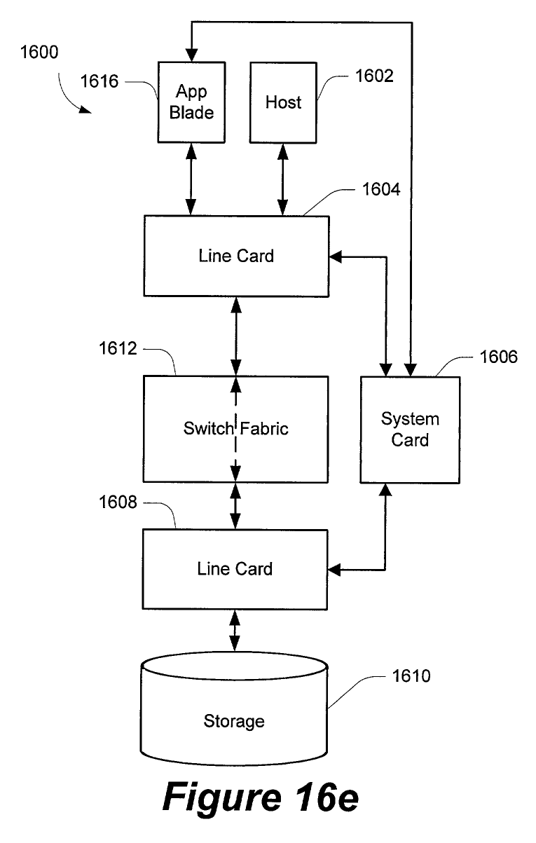

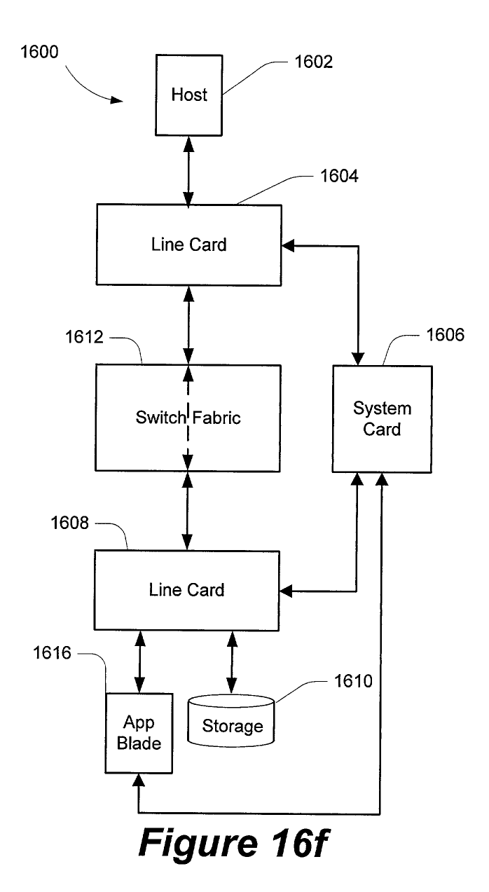

The basic system of the present invention is illustrated in FIG. 16a. The system 1600 is composed of, for example, a host 1602, two line cards 1604 and 1608, a system card 1606, and a storage device 1610. In this illustrative example, the host 1602 may send a write statement that is to be performed (ultimately) by the storage device 1610. However, it will be clear to those skilled in the art that a wide variety of other READ or WRITE scenarios may be envisioned where the host 1602 and/or the storage device 1610 are replaced with other devices that have similar or alternate functionality in conjunction with the storage network switch of the present invention.

According to this illustrative example, the host 1602 is coupled to the first line card 1604. The first line card 1604 itself is coupled to the system card 1606 and the second line card 1608, as illustrated in FIG. 16a. Finally, the second line card 1608 is coupled to the system card 1606 and to the storage device 1610. Accordingly, in this illustrative example, the host 1602 issues, for example, a task in the form of a WRITE statement that is to be carried out by the storage device 1610.

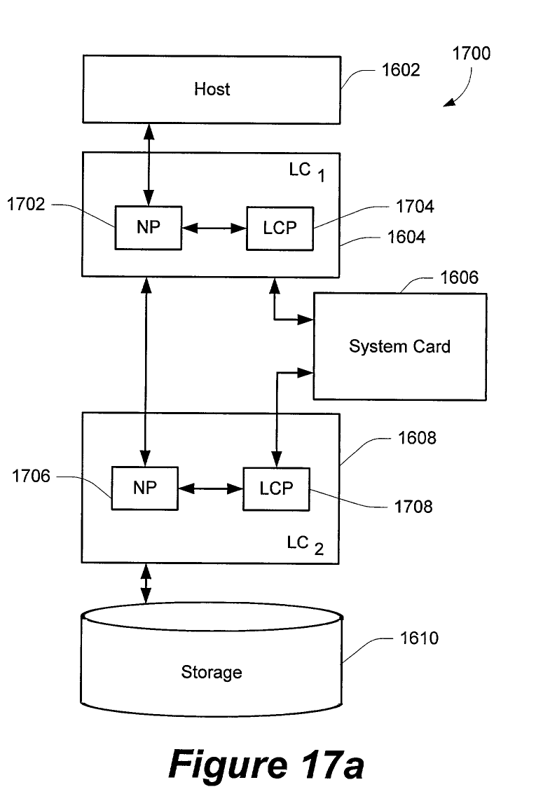

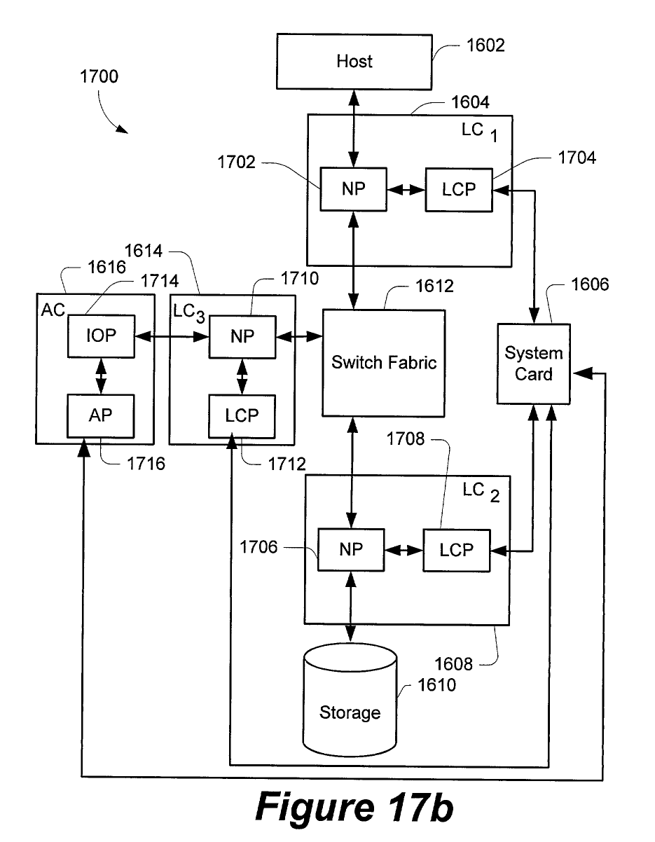

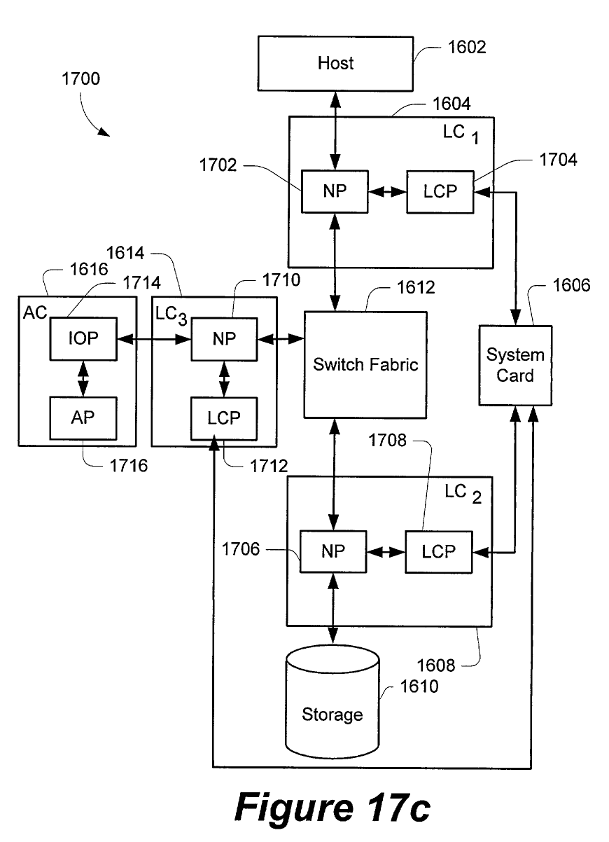

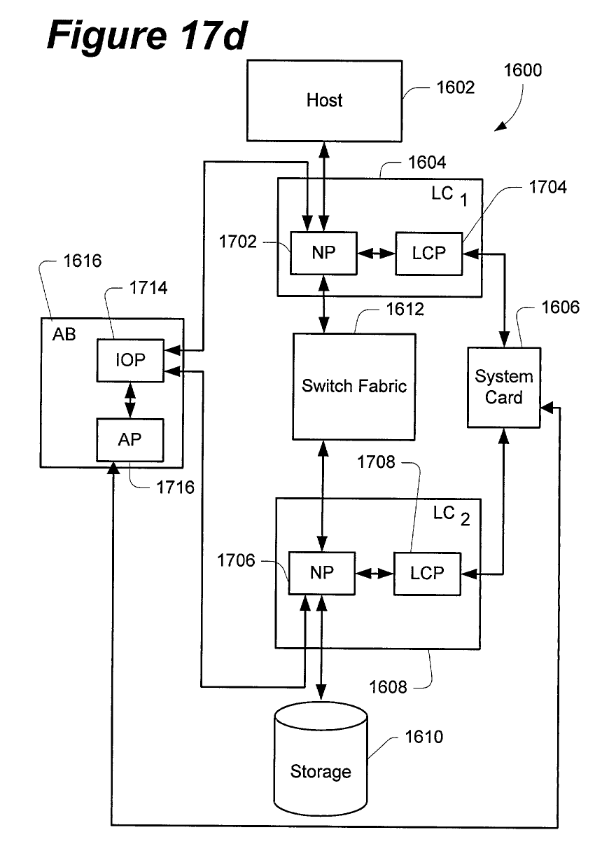

The first and second line cards 1604 and 1608 both have two components. Specifically, the first line card 1604 includes one or more NPs 1702 that are coupled with a LCP 1704 as illustrated in FIG. 17a. Similarly, the second line card 1608 has one or more NP 1706 that are coupled to a LCP 1708. The NP 1702 of the first line card 1604 is coupled directly to the NP 1706 of the second line card 1708, in order to facilitate very fast transmissions of packets, should the opportunity to do so arise. The LCPs 1704 and 1708, however, are both coupled to the system card 1606, as illustrated in FIG. 17a, and these couplings are utilized to communicate route table updates from the system card to the line cards, for the line cards to communicate status to the system control card, and for control packets to be sent and received between the system card and the line card.

### DATA AND CONTROL PATH METHOD OF EXAMPLE 1

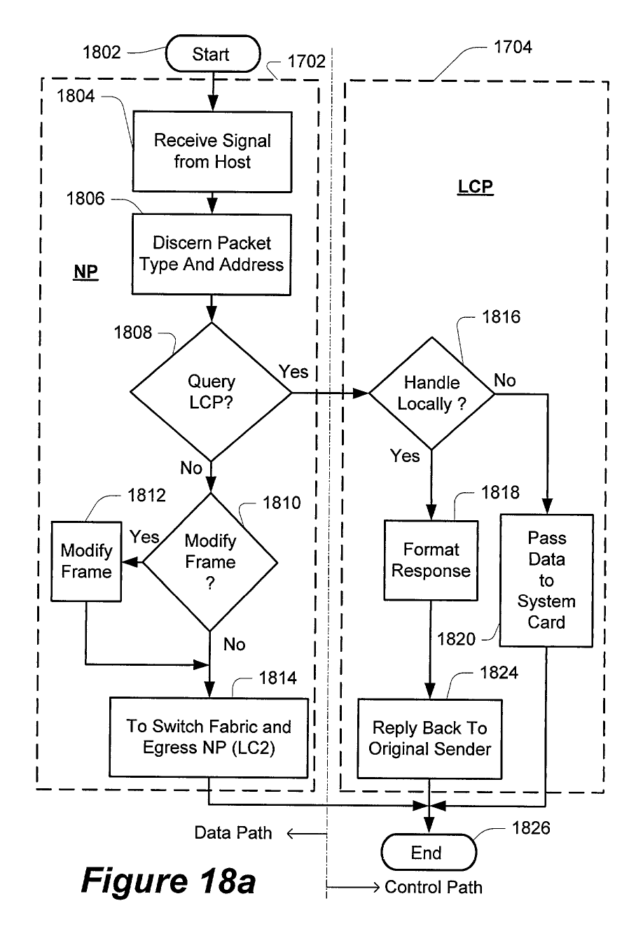

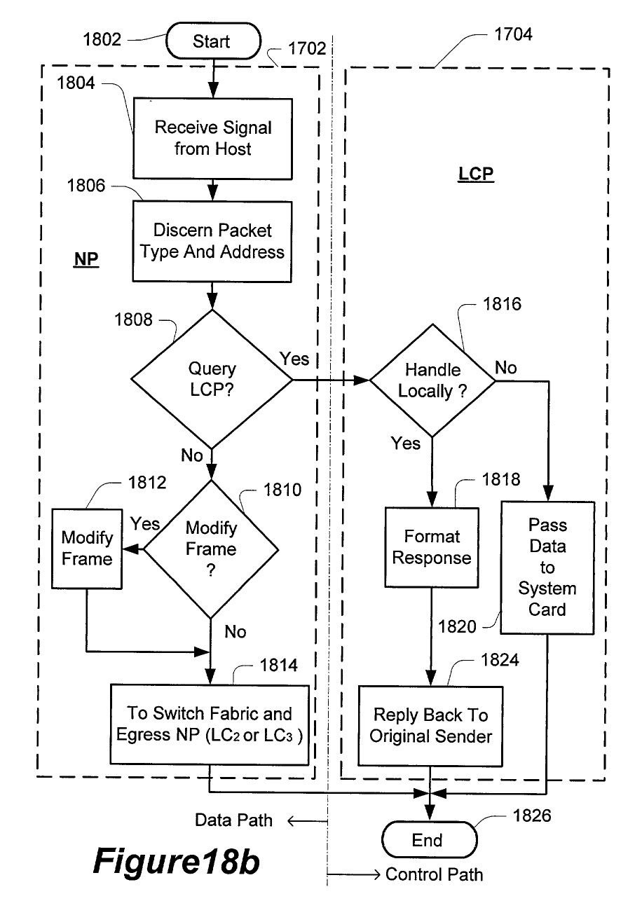

FIG. 18a illustrates an exemplary embodiment of the method of the present invention, namely the data path and the control path. The method 1800 begins, generally, at step 1802 when a statement or signal, typically in the form of a packet, is received by an NP (1702 in FIG. 17a) from the host (1602 of FIG. 17a) by the first line card (1604 of FIG. 17a) in step 1804. Next, in step 1806, the NP (1702 of FIG. 17a) discerns the packet type and address. In decision step 1808, a determination is made whether to forward the ingress packet to the LCP (1704 of FIG. 17a) or to forward the frame directly towards an egress port through the SFS. The NP (1702 of FIG. 17a) makes this determination by examining several fields in the header of the frame including the destination address, source address, protocol type, flags, etc. If the destination address specifies one of the protocol or control services provided internally by the storage network switch, then the frame may be forwarded to the LCP. If the frame has protocol violations (e.g., incorrectly set fields), the packet may be dropped or forwarded to the LCP for error processing. If the frame's destination address and the sources' address do not reside in the same zone on the switch (i.e., the addresses have not been configured by the administrator to allow communication between the two devices represented by the two addresses), the frame may be dropped or forwarded to the LCP for error processing. If none of the above cases occurs, then the NP determines the proper egress port for the destination address and the frame is forwarded to the switch fabric subsystem for transmission to the proper IOS for that egress port. If none of the above scenarios is applicable, i.e., the result of step 1808 is negative, then a determination is made in step 1810 whether or not the frame needs to be modified before it is forwarded to the switch fabric subsystem. The NP may examine the destination address field and the frame type fields of the frame header to determine if the frame is of a specific type destined for a specific address type that requires modification. For example, if the packet is destined for a virtual device address, then the NP must look-up the virtual to physical device mapping and replace the destination address with the address for the actual physical destination device. This is one form of device virtualization. In another example, the NP 1702 decodes the header fields of the frame to determine if the frame is SCSI command frame. If so, the NP 1702 might examine the SCSI command fields, such as the logical unit number (“LUN”) of the target device and the logical block address (“LBA”) being requested, and these fields to a different LUN and LBA mapping. This modification may be done in conjunction with the previous example of modifying the destination address to provide a more sophisticated method of storage device virtualization. If the result of step 1810 is no, then, in step 1814, the packet is sent to the egress line card via the switch fabric where it may ultimately be received by the specific egress NP (1706 of FIG. 17a) for forwarding to the storage device (1610 of FIG. 17a). If the result of step 1810 is yes, then the packet is modified in step 1812 before execution of step 1814. The set of steps outlined above is considered the data path of the present invention. Implementation of the control path of the present invention occurs if the result of step 1808 is positive (i.e., the result of step 1808 is “yes”).

If the result of step 1808 is positive, then the packet is forwarded from the NP (11702 of FIG. 17a) to the LCP (11704 of FIG. 17a) for additional processing along the control path of the present invention. Once within the LCP 1704, at step 1816, a determination is made to see if the packet can be handled by the LCP. This determination includes deciphering the packet header to determine if this is a request or response packet type. All response packets types are forwarded to the SCC 1606 (see FIG. 17a). If it is a request packet, then the LCP 1704 determines if it has enough data locally to be able to format an appropriate response packet. If the result of step 1816 is yes, then a response is formatted in step 1818, and in step 1824, a reply is sent to the original sender, which in this illustrative example is the NP 1702.

If the packet cannot be handled by the LCP 1704 (i.e., the result of step 1816 is no), then in step 1820, the packet is passed to the SCC 1606 for additional processing. The LCP 1704 completes its processing at this time and allows the SCC to process the packet. In step 1824, the processed packet is returned to the original sender, which is NP 1702 in this example illustrated in FIG. 18a. The method ends generally at step 1826.

It should be noted that the destination address need not be for a particular device. For example, the destination address can be for a device attached to the particular line card, or it may be for a device attached to a different portion of the network. The system of the present invention facilitates multiple paths for signals to travel from one device to another. Any one of the multiple paths may be used for transmission of the signal. Some paths, however, provide greater system performance, depending upon the type of signal involved, and the ability of the various devices along those multiple paths to process and/or forward the signal.

### OVERVIEW OF EXAMPLE 2

Another example embodiment of the basic system of the present invention is illustrated in FIG. 16b. The system 1600 is composed of, for example, a host 1602, three line cards 1604, 1608 and 1614, a system card 1606, an application blade 1616, one or more switch fabric card(s) 1612, and a storage device 1610. In this illustrative example, the host 1602 may send a write statement that is to be performed (ultimately) by the storage device 1610. However, it will be clear to those skilled in the art that a wide variety of other READ or WRITE scenarios may be envisioned where the host 1602 and/or the storage device 1610 are replaced with other devices that have similar or alternate functionality in conjunction with the storage network switch of the present invention.

According to this illustrative example of FIG. 16b, the host 1602 is coupled to the first line card 1604. The storage device 1610 is coupled to the second line card 1608. The application blade 1616 is coupled to the third line card 1614 and the system card 1606. The first line card 1604 itself is coupled to the system card 1606 and the switch fabric card(s) 1612, as illustrated in FIG. 16. The second line card 1608 itself is coupled to the system card 1606 and to the switch fabric card(s) 1612. The third line card 1614 itself is coupled to system card 1606 and the switch fabric card(s) 1612. Accordingly, in this illustrative example, the host 1602 issues, for example, a task in the form of a WRITE statement that is to be carried out by the storage device 1610.

The first, second, and third line cards 1604, 1608, and 1614 all have two components. Specifically, the first line card 1604 includes one or more NPs 1702 that are coupled with a LCP 1704 as illustrated in FIG. 17b. Similarly, the second line card 1608 has one or more NP 1706 that are coupled to a LCP 1708. Similarly, the third line card 1614 has one or more NP 1710 that are coupled to a LCP 1712. The NP 1702 of the first line card 1604 is coupled directly to the switch fabric 1612, in order to facilitate very fast transmissions of packets between that NP 1702 and the other NPs 1704 and 1706 on the second and third line cards 1608 and 1614, should the opportunity to do so arise. The LCPs 1704, 1708, and 1710, however, are all coupled to the system card 1606, as illustrated in FIG. 17b, and these couplings are utilized when ingress packets require high-level control processing or if the high level control protocols running on the system card 1606 need to send packets to a host, storage controller, or another switch attached to an I/O port on an NP on a line card. The I/O ports of the NPs on the first, second and third line cards 1702, 1706, and 1710 are connected to the host 1602, storage device 1610, and application blade 1616 respectively.

The application blade 1616 has two components: one or more IOPs 1714 that are coupled with one or more APs 1714 as illustrated in FIG. 17b. The IOP 1714 of the application blade 1616 is coupled directly to the I/O ports of the NPs 1710 of the third line card 1614, in order to facilitate very fast transmissions of packets between the IOPs 1714 and the NPs 1706 on the third line card 1614. The APs 1714, however, can also be coupled to the system card 1606, as illustrated in FIGS. 16c 17c, and these couplings are utilized when high level application control protocols need to configure the application software executing in the APs 1714 on the application blade 1616.

Another example embodiment of the basic system of the present invention is illustrated in FIG. 16c and FIG. 17c. The system 1700 is composed of identical components as illustrated in the embodiment illustrated in FIG. 17b; however, the IOPs 1714 on the application blade 1616 are coupled instead to the NPs 1702, 1704, and 1706 of the first, the second, and the third line cards 1604, 1608, and 1614, respectively. The embodiment illustrated in FIG. 16c and FIG. 17c demonstrates that the data path connectivity for the application blade 1616 is not limited to any particular line card 1604, 1608, or 1614 in the example system.

### DATA AND CONTROL PATH METHOD OF EXAMPLE 2

FIG. 18b illustrates the primary method of the present invention, namely the data path and the control path method. The method 1800 begins generally at step 1802 when a statement or signal, typically in the form of a packet, is received by an NP (1702 in FIG. 17b) from the host (1602 of FIG. 17b) by the first line card (1604 of FIG. 17b) in step 1804. Next, in step 1806, the NP (1702 of FIG. 17b) discerns the packet type and address. In decision step 1808, a determination is made whether to forward the ingress packet to the LCP (1704 of FIG. 17b) or to forward the frame directly towards an egress port through the SFS. The NP (1702 of FIG. 17b) makes this determination by examining several fields in the header of the frame including the destination address, source address, protocol type, flags, etc. If the destination address specifies one of the protocol or control services provided internally by the storage network switch, then the frame may be forwarded to the LCP. If the frame has protocol violations (e.g., incorrectly set fields), the packet may be dropped or forwarded to the LCP for error processing. If the frame's destination address and the sources' address do not reside in the same zone on the switch (i.e., the addresses have not been configured by the administrator to allow communication between the two devices represented by the two addresses), the frame may be dropped or forwarded to the LCP for error processing. If none of the above cases occurs, then the NP determines the proper egress port for the destination address and the frame is forwarded to the switch fabric subsystem for transmission to the proper NP for that egress port. If none of the above scenarios is applicable, i.e., the result of step 1808 is negative, then a determination is made in step 1810 whether or not the frame needs to be modified before it is forwarded to the switch fabric subsystem. The NP may examine the destination address field and the frame type fields of the frame header to determine if the frame is of a specific type destined for a specific address type that requires modification. For example, if the packet is destined for a virtual device address, then the NP must look-up the virtual to physical device mapping and replace the destination address with the address for the actual physical destination device. This is one form of device virtualization. In another example, the NP 1702 decodes the header fields of the frame to determine if the frame is SCSI command frame. If so, the NP 1702 might examine the SCSI command fields, such as the logical unit number (“LUN”) of the target device and the logical block address (“LBA”) being requested, and modify these fields to a different LUN and LBA mapping. This modification may be done in conjunction with the previous example of modifying the destination address to provide a more sophisticated method of storage device virtualization. If the result of step 1810 is no, then, in step 1814, the packet is sent to the egress line card via the switch fabric where it may ultimately be received by the specific egress NP (1706 of FIG. 17b) for forwarding to the storage device (1610 of FIG. 17b). If the result of step 1810 is yes, then the packet is modified in step 1812 before execution of step 1814. The set of steps outlined above is considered the data path of the present invention. Implementation of the control path of the present invention occurs if the result of step 1808 is positive (i.e., the result of step 1808 is “yes”).

If the result of step 1808 is positive, then the packet is forwarded from the NP (1702 of FIG. 17b) to the LCP (1704 of FIG. 17b) for additional processing along the control path of the present invention. Once within the LCP 1704, at step 1816, a determination is made to see if the packet can be handled by the LCP. This determination includes deciphering the packet header to determine if this is a request or response packet type. All response packets types are forwarded to the SCC 1606 (see FIG. 17b). If it is a request packet, then the LCP 1704 determines if it has enough data locally to be able to format an appropriate response packet. If the result of step 1816 is yes, then a response is formatted in step 1818, and in step 1824, a reply is sent to the original sender, which in this illustrative example is the host 1602 via NP 1702 to which it is attached, by passing the formatted response packet to the NP 1702 for forwarding to the I/O port attached to the host.

If the packet cannot be handled by the LCP 1704 (i.e., the result of step 1816 is no), then in step 1820, the packet is passed to the SCC 1606 for additional processing. The LCP 1704 completes its processing at this time and allows the SCC to process the packet. The method ends generally at step 1826.

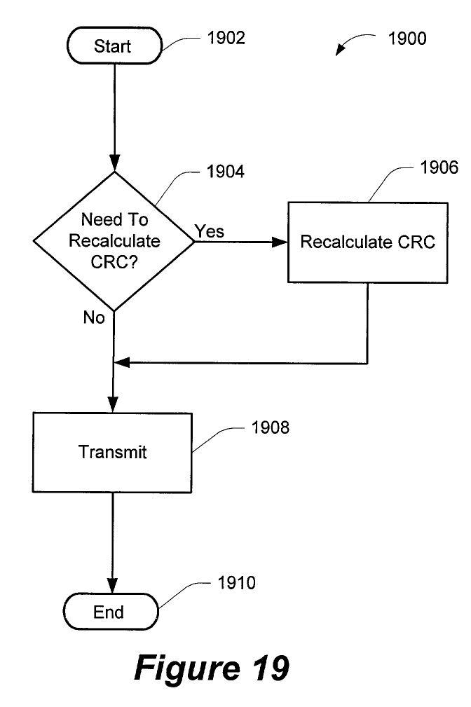

It should be noted that the egress path of the packet (the portion of the total path where the packet is about to be sent to its final destination) is illustrated in FIG. 19. Referring to FIG. 19, the egress portion of the data path begins generally at step 1902. In step 1904, a determination is made to see if the CRC of the packet needs to be recalculated. If the result of step 1904 is negative (i.e., “no”), the packet is transmitted to its final destination in step 1908 and the method ends generally at step 1910. Otherwise, i.e., the result of step 1904 is positive or “yes,” then the CRC is recalculated in step 1906 before the packet is sent to its final destination in step 1908. The egress portion of the data path method of the present invention ends generally at step 1910.

### OTHER SYSTEM EXAMPLES

FIG. 16d illustrates yet another alternate embodiment of the present invention that is similar to the embodiment of FIG. 16c, except that the application blade 1616 is also coupled to the first line card 1604 and to the second line card 1608, providing yet another set of signal paths between the host 1606, the application blade 1616, and the receiving device 1610.

FIG. 16e illustrates yet another alternate embodiment of the basic system of the present invention. In this alternate embodiment, the application blade 1616 and the host 1602 are coupled to the first (ingress) line card 1604. As in some of the previous examples, the first line card 1604 is coupled to the switch fabric 1612 and to the system card 1606. The second (egress) line card 1608 is coupled to the switch fabric 1612 and to the system card 1606. Thus, in this alternate embodiment, the signal can be sent, for example, by either the application blade 1616 or the host 1602 directly through the first and second line cards 1604 and 1608 via the switch fabric 1612 to the receiving device, such as storage device 1610. The application blade 1616 is also coupled to the system card 1606, to allow the application blade 1616 to be controlled and monitored by the system card 1610.

Yet another alternate embodiment of the basic system of the present invention is illustrated in FIG. 16f is similar to the embodiment of FIG. 16e, except that the application blade 1616 is coupled to the second line card 1608 as well as the system card 1606.

FIG. 17d illustrates yet another illustration of the alternate embodiment of the present invention shown in FIG. 16f The coupling between the application blade 1616 to the first line card 1604 and the second line card 1608 are illustrated as an example. Specifically, the IOP 1714 of the application blade 1616 is coupled to the network processor 1702 of the first line card 1604 and to the network processor 1706 of the second line card 1608.

### Control Path Processing

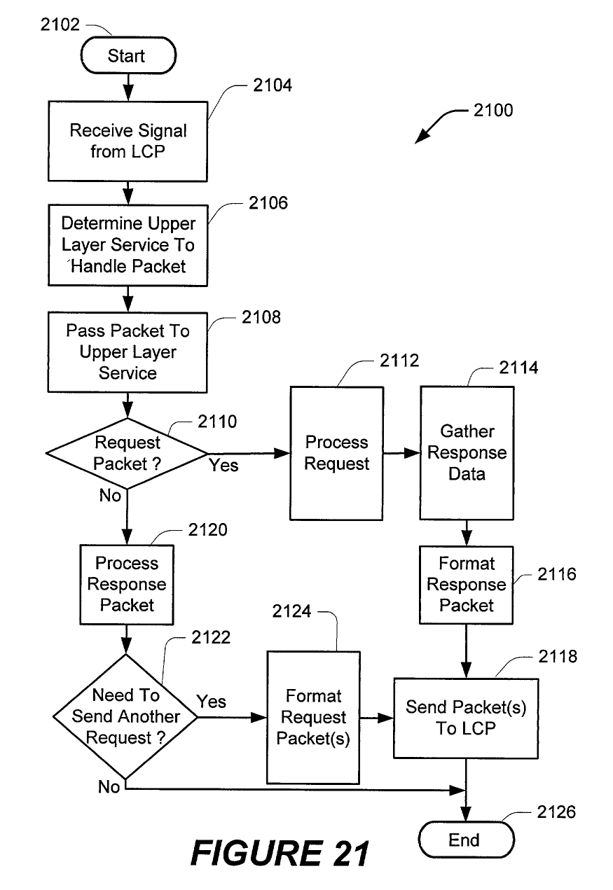

FIG. 21 in method 2100 illustrates the control path processing that takes place on the SCP located on the SCC. In step 2104, the SCP 1184 (see FIG. 13) receives the packet from the LCP after it was transmitted over the IPC link between the two processors. This would happen as a result of step 1820 in FIG. 18. In step 2106, the SCP 1184 code determines what upper layer protocol server process may handle the processing of the packet. This is usually determined by examining the fields in the packet header. The present invention also accommodates the method of the NP and/or LCP placing additional packet tagging information into the packet (because these devices have already examined the packet headers) such that the SCP 1184 merely examines the tag and makes a simple branch call to the appropriate processing software for that packet type based on the tag value. In step 2108, the packet is actually passed to one of the upper layer protocol service tasks or processes. In step 2110, the software of the SCP 1184 determines if this packet is a new request from an external device. If the result of step 2110 is positive (i.e., “yes”), then the request is processed in step 2112. In step 2114, the SCP 1184 code gathers the data necessary to respond to the request. For example, if the request for a search of the name server database, the name server process may find the requested information in the database. In step 2116, the SCP 1184 formats a response packet to the request that includes the requested data, or formats an error response if the request was invalid or the requested data was not found. In step 2118, the SCP 1184 sends the packet to the LCP via the IPC network that connects the two processors.

If the incoming packet is a response packet (i.e., the result of 2110 is no), then in step 2120, the SCP 1184 (see FIG. 13) processes the response packet and uses the data in the response to update protocol states, databases, and other protocol specific upper layer protocol data structures as appropriate. In step 2122, the software on the SCP 1184 (see FIG. 13) determines if the data it received causes the protocol to need additional information from the responding external device or another external device. If the result of step 2122 is positive (i.e., “yes”), then, in step 2124 the protocol software formats an appropriate request packet with the appropriate header information to direct the packet to the appropriate external device. The protocol software then proceeds to step 2118 where the packet is sent to the appropriate LCP 1704 via the IPC 1204 network, and ends generally at step 2126.

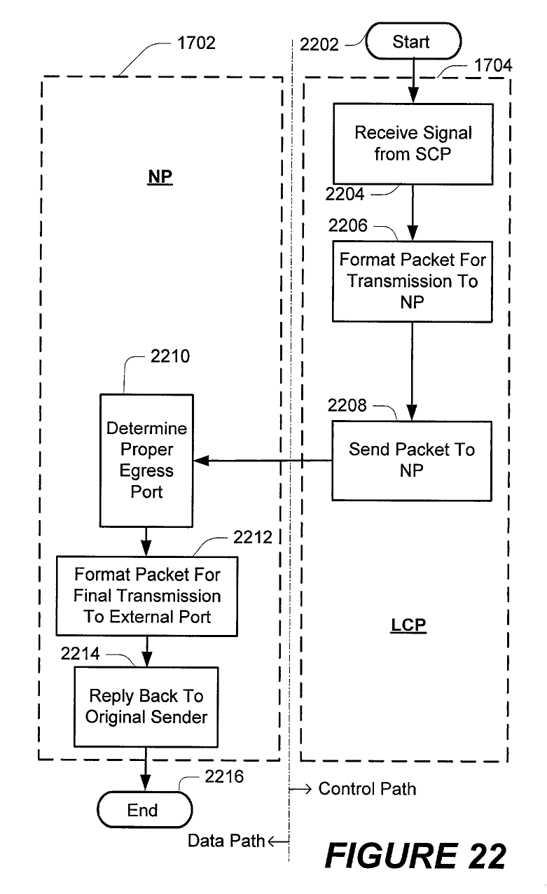

FIG. 22 illustrates another control path processing flow that takes place on the Line Card Processor (“LCP”) 1704. The method begins generally at step 2202 and moves to step 2204, wherein the LCP 1704 receives the packet from the SCP 1184 (see FIG. 11) after it was transmitted over the IPC 1302 link between the two processors. This event would happen as a result of step 2118 in FIG. 21. In step 2206, the LCP 1704 formats the packet with the appropriate information to pass to a local NP 1702 for transmission to an external port. In step 2208, the LCP 1704 sends the packet to one of the local NPs 1702 on the line card via the data bus, e.g., PCI. In step 2210, the NP 1702 receives the packet and determines the appropriate external egress port to which to send the packet. In step 2212, the NP 1702 performs the final formatting of the packet headers and data, including CRC generation. In step 2214, the NP 1702 transmits the packet out the external port to the attached network device of the original sender (of FIG. 22), ending generally at step 2216.

Steps 1816 through 1824 in FIG. 18, steps 2104 through 2124 in FIG. 21, and steps 2204 through 2214 in FIG. 22 constitute the control path of the present invention. In all scenarios, the method of FIG. 18 ends generally at step 1826, the method of FIG. 21 ends generally at step 2126, and the method of FIG. 22 ends generally at step 2216, respectively.

### Application Path Method

The application path portion of the method of the present invention is composed of four major methods: the application path control method, the application ingress processing method, the application command processing method, and the application response processing method.

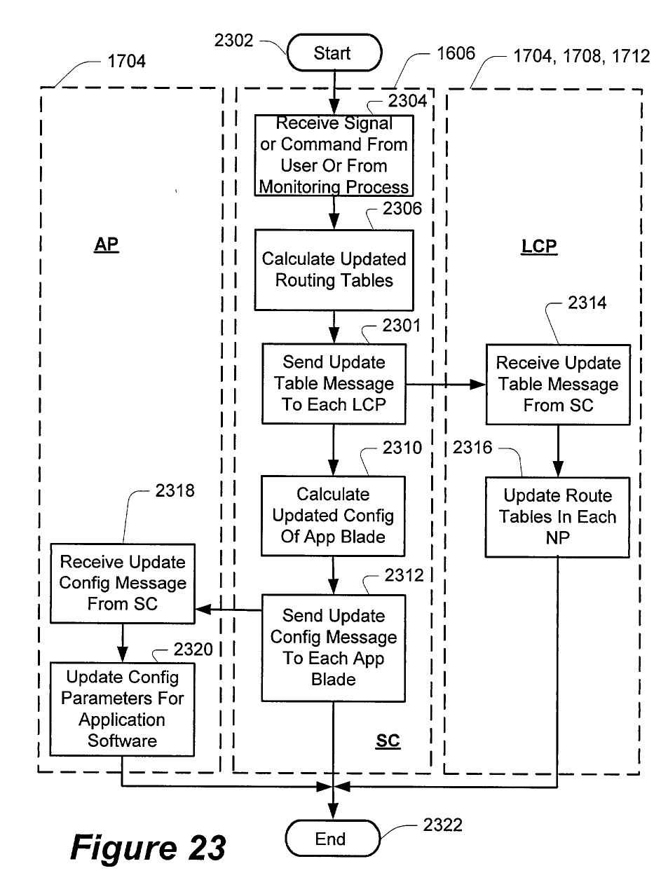

The application control process is illustrated in FIG. 23. The application control process involves the steps necessary for allowing a user of the storage network switch to configure the proper packet routing and processing by the combination of line cards and application blades present in the system. The application control process method generally begins at step 2302 where a control process executing on the system card 1606 receives a user command or signal that indicates that a particular upper layer application function needs to be enabled or configured in the system. Thereafter, in step 2304, the system card 1606 calculates the appropriate routing table changes that are required to be loaded into the NPs 1702, 1706, and 1710 on all line cards 1604, 1608, and 1614 that will allow packets to be routed to the appropriate application blade 1616 (see FIGS. 16c and 17c). Once the route tables have been calculated, step 2308 is performed, where the system card 1616 sends a “route table update” message to each of the LCPs 1704, 1708, and 1712 on each of the line cards 1604, 1608, and 1614 in the system. Then, in step 2310, the system card 1616 calculates a set of updated configuration parameters for the application blade. Once the application configuration parameters have been calculated, step 2312 is performed, where the system card 1616 sends a “configuration parameters update” message to each of the APs 1716 on each of the application blades 1616 in the system.

The LCP processing method upon receipt of the “route table update” message is encapsulated in steps 2314 and 2316. In step 2314, the LCP 1704, 1708, or 1712 receives the “route table update” message or signal from the SC 1606 and extracts the route table entries that need to be added, deleted or replaced in the routing table. In step 2316, the LCP 1704, 1708, or 1712 writes or transfers the route table into the route table memory of the NP 1702, 1706, or 1710 respectively.

The AP processing method upon receipt of the “configuration parameters update” message is encapsulated in steps 2318 and 2320. In step 2318, the AP 1716 receives the “configuration parameters update” message or signal from the SC 1606 and extracts the application configuration parameters that need to be added, deleted or replaced in the application configuration files and memory based data structures. In step 2320, the AP 1716 writes the configuration files and memory based data structures to enable the updated configuration of the application software executing on the AP 1716. The method of FIG. 23 ends generally at step 2322.

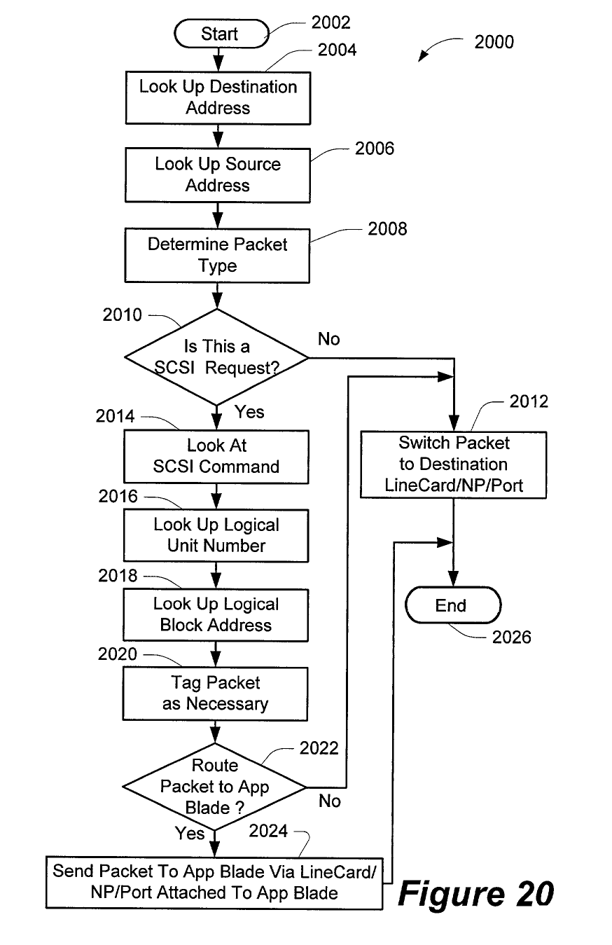

The application ingress processing method is encapsulated in steps 1810 and 1812 of FIG. 18. The application ingress processing method itself is illustrated in FIG. 20. The application ingress processing path begins generally at step 2002, which occurs after the NP 1702 has decided that the packet is not a control path packet that is destined for the LCP 1704 (step 1808 of FIG. 18). Thereafter, in step 2004, the destination address is looked up. Next, in step 2006, the source address is looked up. Then, in step 2008, the packet type is determined. Once the packet type is determined, step 2010 is performed, where it is determined whether or not the packet is a SCSI request. If not (i.e., the result of step 2010 is no), then in step 2012 the packet is switched to the destination line card/NP and, ultimately, to the destination port associated with the NP (the same step as step 1814 in FIG. 18). Otherwise (i.e., the result of step 2010 is yes), then the SCSI command is looked up from a lookup table in step 2014. The logical unit number is looked up in step 2016. The logical block address is then looked up in step 2018. The packet is then tagged as necessary in step 2020. The NP 1702 places additional packet tagging information into the packet because it has already examined the packet headers such that the application blade merely examines the tag and makes a simple branch call to the appropriate processing software for that packet type based on the tag value. This allows the application software to not have to re-process all the information that was already parsed by the NP 1702 to allow the AP on the application blade to maximize its available bandwidth for processing the storage request itself. Next, in step 2022, a decision is made whether or not to route the packet to the application device (application blade). The determination to forward the packet to the application blade is based on whether or not the packet needs simple modification (i.e., updating the destination address, logical block address, or logic unit number information) or if the packet needs more sophisticated processing required to be done in the application blade (e.g., RAID functionality, caching, etc.). If not (i.e., the result of step 2022 is no), then step 2012 is performed (as described above). Otherwise (i.e., the result of step 2022 is “yes”), the packet is sent to the application device (application blade) in step 2024. In step 2024, the packet is actually forwarded to the line card that is attached to the I/O ports of the application blade. This is illustrated in FIG. 17b where the NP 1702 on the first line card would forward the packet via the switch fabric 1712 to the NP 1710 on the third line card. The NP 1710 on the third line card will then forward the packet to the application blade 1616 that is attached to at least one of the I/O ports of the NP 1710. The method of FIG. 20 ends generally at step 2026.

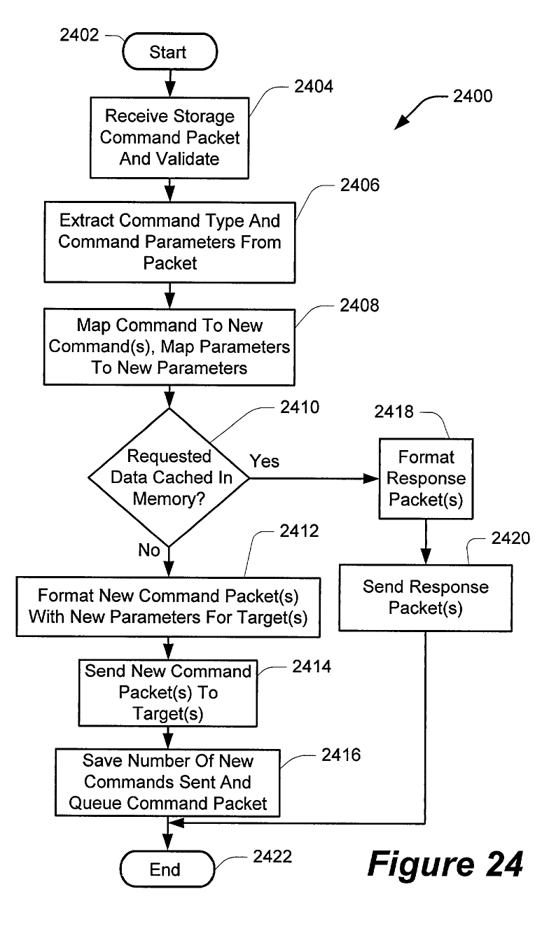

The application command processing method is illustrated in FIG. 24. The application command processing path begins generally at step 2402, which occurs after the AP 1716 has received a signal indicating that a packet has arrived for high level application processing. This is the same packet sent in step 2024 in FIG. 20. Thereafter, in step 2404, the AP 1716 processes the received command packet and validates the fields within the packet. In step 2406, the AP 1716 extracts the command type and command parameters from the packet fields. In step 2408, the AP 1716 maps the requested command to a set of new commands that it must issue to one or more storage target devices 1610. Also in step 2408, the AP 1716 remaps or translates the other parameters for the command like the storage target device address, logical block number, logical unit numbers, etc. The result of step 2408 is that the AP 1716 creates one or more new commands that will achieve the desired results of te original received command. Thereafter, in step 2410, the AP 1716 discerns whether the command is a request for data and determines is the data has been previously fetched from the storage devices is remains cached in memory or local storage. If the result of step 2410 is true, then the AP 1716 executes step 2418 where one or more response packets are formatted with the requested data included and in step 2420 sends the packet(s) to the source address of the original command packet (e.g., the host 1602) received by the application blade 1616 and then frees the memory utilized by the command packet and terminates at step 2422. If the result of step 2410 is negative, then in step 2412, the AP 1716 formats one or more new command packets to be sent in step 2414 to one or more storage targets 1610. In step 2416, the AP 1716 saves the number of new command packets generated, queues the original command packet received on a waiting queue, and generally terminates processing at step 2422.

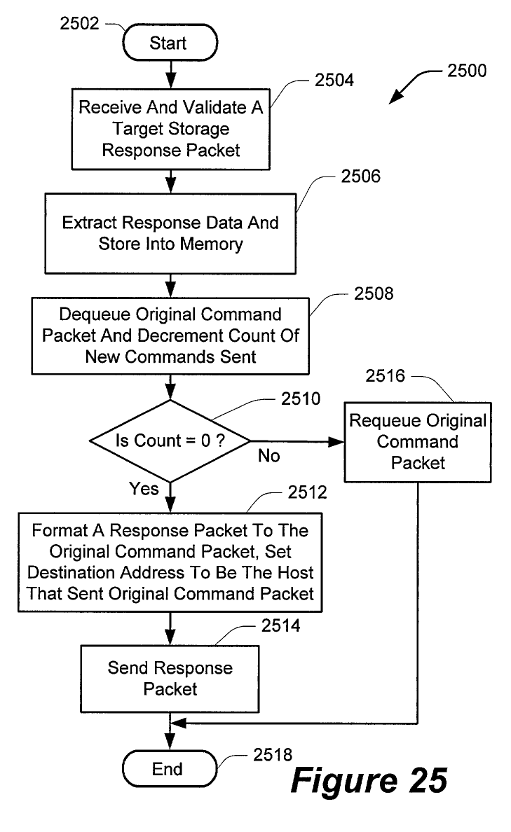

The application response processing method is illustrated in FIG. 25. The application response processing path begins generally at step 2502, which occurs after the AP 1716 has received a signal indicating that a packet has arrived for processing and the AP decerns that this is a response packet from one of the storage target devices 1610. Thereafter, in step 2504, the AP 1716 processes the received response packet and validates the fields within the packet. In step 2506, the AP 1716 extracts the response data from the packet and stores this data into memory. If this was a read request, the AP 1716 may create data structures to keep this data in memory for an extended period of time to implement a cache for future request for the same data. In step 2508, the AP 1716 dequeues the original command packet received in step 2402 of FIG. 24 and decrements a counter representing the number of new commands issues to the storage target device(s) 1610. This count serves to represent the number of responses the AP 1716 expects to receive before combining all response data to format a response for the original command packet. In step 2510, the AP 1716 discerns whether this counter has reached zero, indicating that all expected responses have been received. If the result of step 2510 is negative, then in step 2516, the AP 1716 requeues the original command packet in a waiting queue, and generally terminates in step 2518. If the result of step 2510 is positive, then the AP 1716 will execute step 2512 where one or more response packets for the original command packet are formatted using the accumulated data received the responses from the one or more commands sent to the one or more storage target devices 1610. In step 2514, the AP 1716 then transmits the response packet(s), frees the resources used by the original request packet and the process generally terminates in step 2518.

### Distributed Processing

The highly distributed nature of the present invention, such as the widespread dissemination of look-up addresses, among other information, among the large numbers of LCPs and NPs, is a key factor in the scalability of the present invention. Moreover, the widespread use of multiple processors running in parallel is a key factor for high performance. The combination of distributed processing and near-massive parallel processing provides the unexpectedly high performance of the present invention.

The two types of operations that are best moved to NPs in order to fully take advantage of their distributed processing nature are: header field look-ups and header field modifications. There are many types of look-up operations that can take advantage of the look-up accelerators provided in most NPs. For example, most NPs support direct table look-ups, hash tree look-ups, and binary tree look-ups. More sophisticated NPs allow full string pattern matching capabilities for very complex, high performance look-up operations. Example packet header fields that are used in look-up operations include the packet destination address field, packet source address field, packet type fields, packet priority fields, packet tag fields, SCSI command type field, SCSI logical unit number field, and logical block address field. The destination address field is used to determine to what physical port in the SNS to forward the packet and the look-up operation does a direct map or hash table look-up to find the egress port identifier for the egress port. Both the destination and source address fields are typically used to hash zone information or security information for the ingress and egress devices represented by the addresses. If the zone or security information indicates that the two ports may communicate, the packet is forwarded; otherwise, the packet is dropped or an error reply can be generated. In addition, the destination address look-up operation may have the result that indicates that the packet header must be modified in order to support the next hop when the packet is forwarded. The packet type and packet priority fields are used to determine how to route the packet (i.e., to which queue to place the packet). The SCSI command type, logical unit number, and logical block addresses are used to look-up whether the packet needs to be redirected to the application blade for higher levels of processing, or to determine whether the fields need to be modified. If the fields are to be modified, then the results of the look-up operation yields the new fields with which to replace the old fields in the packet.

Header field modification is an attribute of NPs that allow wire rate modifications to the packet header fields so that high-level processors, such as those on the application blade, do not have to be involved in the processing of the packet. Simple types of modifications include replacing address fields (converting virtual addresses to physical addresses), address swapping (used for IP router type functionality), and upper layer protocol field modifications (changing SCSI commands, SCSI logical unit numbers, and SCSI logical block numbers). Allowing these type of modifications at the data path in the NP software provides for the two major benefits: 1) allows more sophisticated processing of the data stream without having to send the packets to an application blade, and 2) allows a sophisticated level of preprocessing to the packet stream to help off-load the processing of the packets by the application blade if the packets must still be sent there for final processing.

### Network Management System Path

The present invention may also be fitted with a Network Management System (“NMS”) path. The NMS path is used to configure and control the switch of the present invention, or to modify the behavior of the switch of the present invention. The NMS path is also useful for monitoring traffic along the switch, for example, for law enforcement requirements.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described exemplary embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A storage network switch, comprising:
a switch fabric subsystem;
an input-output subsystem coupled to said switch fabric subsystem;
an application subsystem coupled to said switch fabric subsystem; and
a system control subsystem coupled to said switch fabric subsystem, said input-output subsystem and said application subsystem.

2. The storage network switch of claim 1, future comprising a plurality of input-output subsystems coupled to said switch fabric subsystem.

3. The storage network switch of claim 1, future comprising a plurality of application subsystems coupled to said switch fabric subsystem.

4. The storage network switch of claim 1, wherein said input-output subsystem is adapted for coupling to external network devices.

5. The storage network switch of claim 1, where in said switch fabric subsystem comprises a plurality of switch devices, each of the plurality of switch devices having a plurality of ingress ports and a plurality of egress ports.

6. The storage network switch of claim 5, wherein the plurality of ingress ports and the plurality of egress ports are differential signal ports.

7. The storage network switch of claim 6, wherein a one of the plurality of ingress ports is paired with a respective one of the plurality of egress ports.

8. The storage network switch of claim 7, wherein a pair of ingress and egress ports are coupled to said input-output subsystem.

9. The storage network switch of claim 7, wherein a pair of ingress and egress ports are coupled to said application subsystem.

10. The storage network switch of claim 7, wherein a plurality of pairs of ingress and egress ports are coupled to said input-output subsystem for redundancy.

11. A storage network system comprising:
a host;
an ingress line card coupled to said host;
a storage device;
an egress line card coupled to said storage device; and
a system card coupled to said ingress line card and to said egress line card;
wherein the couplings enable signals from said host to said storage device to travel in any one of multiple paths.

12. The storage network system of claim 11, wherein said ingress line card has at least one network processor.

13. The storage network system of claim 12, wherein said egress line card has at least one network processor.

14. The storage network system of claim 13, wherein if said network processor on said ingress line card can process a signal received from said host, then sending said signal to said network processor of said egress line card, said network processor of said egress line card then forwarding said signal to said storage device.

15. The storage network system of claim 14, said switch further comprising a switch fabric coupled to said ingress line card and said egress line card, wherein said ingress line card processor sends said signal to said egress line card via said switch fabric.

16. The storage network system of claim 14, wherein said ingress line card has a line card processor.

17. The storage network system of claim 16, wherein said egress line card has a line card processor.

18. A storage network system comprising:
a host;
an ingress line card coupled to said host;
a storage device;
an egress line card coupled to said storage device;
an application blade;
an application line card coupled to said application blade;
a system card coupled to said ingress line card, to said egress line card, and to said application line card; and
a switch fabric coupled to said ingress line card, to said egress line card, and to said application line card.

19. The storage network system of claim 18, wherein said ingress line card has at least one network processor.

20. The storage network system of claim 19, wherein said egress line card has at least one network processor.

21. The storage network system of claim 20, wherein if said network processor on said ingress line card can process a signal received from said host, then sending said signal to said network processor of said egress line card via said switch fabric, said network processor of said egress line card then forwarding said signal to said storage device.

22. The storage network system of claim 21, wherein said ingress line card has a line card processor.

23. The storage network system of claim 22, wherein said egress line card has a line card processor.

24. The storage network system of claim 23, wherein said application line card has a line card processor.

25. The storage network system of claim 24, wherein said application blade has at least one application processor.

26. The storage network system of claim 25, wherein if said signal from said host cannot be processed with said network processor of said ingress line card, then sending said signal to said line card processor of said ingress line card.

27. The storage network system of claim 26, wherein if said line card processor of said ingress line card can process said signal, then processing said signal to generate a processed signal with said line card processor of said ingress line card and returning said processed signal to said network processor of said ingress line card, and forwarding said processed signal back to said host.

28. The storage network system of claim 27, wherein if said line card processor of said ingress line card cannot process said signal, then forwarding said signal to said system card, said system card then processing said signal to generate a processed signal, said system card then forwarding said processed signal to said line card processor of said ingress line card, said line card processor of said ingress line card then forwarding said processed signal to said network processor of said ingress line card, said network processor of said ingress line card then forwarding said processed signal to said host.

29. The storage network switch of claim 28, further comprising a network controller coupled to the processor interface and memory controller.

30. The storage network switch of claim 29, wherein the least one network controller is configured for an Ethernet network.

31. The storage network switch of claim 1, wherein said system control subsystem comprises:
a system control processor;
a processor interface and memory controller having at least one input-output bus, the processor interface and memory controller is coupled to the system control processor;
a memory coupled to the processor interface and memory controller;
a redundancy control coupled to the processor interface and memory controller; and
a plurality of network controllers coupled to the at least one input-output bus of the processor interface and memory controller.

32. The storage network switch of claim 31, wherein the plurality of network controllers are configured for an Ethernet network.

33. A scalable switch fabric system for computer networks, said system comprising:
at least one input-output subsystem coupled to at least one computer network;
a switch fabric subsystem coupled to said at least one input-output subsystem;
an application subsystem coupled to said switch fabric subsystem; and
a system control subsystem coupled to said switch fabric subsystem, said input-output subsystem and said application subsystem.

34. The scalable switch fabric system of claim 33, wherein said at least one input-output subsystem comprises:
an ingress line card having an ingress switch fabric interface coupled to said switch fabric subsystem; and
an egress line card having an egress switch fabric interface coupled to said switch fabric subsystem.

35. The scalable switch fabric system of claim 34, wherein the ingress line card comprises:
a plurality of ingress network processors;
an ingress bridge coupled between the plurality of ingress network processors and the ingress switch fabric interface; and
an ingress line card processor coupled to the plurality of ingress network processors.

36. The scalable switch fabric system of claim 35, wherein each of the plurality of ingress network processors has an executive processor and a fabric coprocessor.

37. The scalable switch fabric system of claim 35, further comprising an ingress network controller.

38. The scalable switch fabric system of claim 37, wherein the ingress network controller is configured for an Ethernet network.

39. The scalable switch fabric system of claim 34, wherein the egress line card comprises:
a plurality of egress network processors;
an egress bridge coupled between the plurality of egress network processors and the egress switch fabric interface; and
an egress line card processor coupled to the plurality of egress network processors.

40. The scalable switch fabric system of claim 39, wherein each of the plurality of egress network processors has an executive processor and a fabric coprocessor.

41. The scalable switch fabric system of claim 39, further comprising an egress network controller.

42. The scalable switch fabric system of claim 41, wherein the egress network controller is configured for an Ethernet network.

43. The scalable switch fabric system of claim 33, wherein said system control subsystem comprises a system control card having a system control card processor and a system control card network controller.

44. The scalable switch fabric system of claim 43, wherein the system control card network controller is configured for an Ethernet network.

45. The scalable switch fabric system of claim 33, wherein said application subsystem comprises:
at least one application processor;
an application memory coupled to the at least one application processor; and
an application switch fabric interface coupled between the at least one application processor and said switch fabric subsystem.

46. The scalable switch fabric system of claim 45, further comprising an application processor network controller.

47. The scalable switch fabric system of claim 46, wherein the application processor network controller is configured for an Ethernet network.

48. The scalable switch fabric system of claim 33, wherein a plurality of input-output subsystems and a plurality of application systems are configured to be redundant.
